(19) United States
(12) Patent Application Publication
(10) Pub. No.: US 2025/0097755 A1
(43) Pub. Date: Mar. 20, 2025

(54) MEASUREMENT PROCESSING METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventors: Dajie JIANG, Dongguan (CN); Jianzhi LI, Dongguan (CN)

(73) Assignee: VIVO MOBILE COMMUNICATION CO., LTD., Dongguan (CN)

(21) Appl. No.: 18/964,218

(22) Filed: Nov. 29, 2024

Related U.S. Application Data
(63) Continuation of application No. PCT/CN2023/095791, filed on May 23, 2023.

(30) Foreign Application Priority Data
May 30, 2022 (CN) 202210605828.4

(51) Int. Cl. H04W 24/10; H04W 24/08

(52) U.S. Cl. CPC H04W 24/10; H04W 24/08

(57) ABSTRACT

A measurement processing method and a communication device are provided. The method includes: measuring, by a terminal, a first signal; and sending, by the terminal, a first measurement report to a first device or a serving cell of the terminal. A measurement quantity for the terminal to measure the first signal includes at least one of: a sensing measurement quantity; a sensing performance evaluation index; or a sensing measurement result. The first signal includes at least one of a sensing signal, a reference signal, a synchronization signal, or a data signal sent by the serving cell of the terminal or candidate target cells. The first device includes at least one of a sensing network function, a sensing network element, or a sensing management function.

### CROSS-REFERENCE TO RELATED APPLICATIONS

This application is a continuation of International Application No. PCT/CN2023/095791, filed on May 23, 2023, which claims priority to Chinese Patent Application No. 202210605828.4 filed on May 30, 2022. The entire contents of each of the above-referenced applications are expressly incorporated herein by reference.

### TECHNICAL FIELD

This application belongs to the technical field of communication, and in particular relates to a measurement processing method and apparatus, a communication device, and a readable storage medium.

### BACKGROUND

Future mobile communication systems, such as Beyond Fifth Generation (B5G) system or sixth-generation (6G) system, will have not only communication capabilities, but also sensing capabilities. Sensing capabilities refer to that one or more devices with sensing capabilities can sense the orientation, distance, speed, and other information of target objects through wireless signal sending and reception, or perform detection, tracking, identification, imaging and the like on target objects, events, or environments etc. In the future, with the deployment of small base stations with high-frequency and large bandwidth capabilities such as millimeter waves and terahertz waves in 6G networks, the sensing resolution will be significantly improved compared to centimeter waves, enabling 6G networks to provide more refined sensing services.

How to maintain the continuity of sensing services in a case of switching of a base station participating in a sensing process is an urgent problem to be solved.

### SUMMARY

Embodiments of this application provide a measurement processing method and apparatus, a communication device and a readable storage medium.

In a first aspect, a measurement processing method is provided, including:
measuring, by a terminal, a first signal; and
sending, by the terminal, a first measurement report to a first device or a serving cell of the terminal,
where a measurement quantity for the terminal to measure the first signal includes at least one of:
a sensing measurement quantity;
a sensing performance evaluation index; and
a sensing measurement result;
the first signal includes at least one of a sensing signal, a reference signal, a synchronization signal and a data signal sent by the serving cell of the terminal or candidate target cells; and
the first device includes at least one of a sensing network function, a sensing network element and a sensing management function.

In a second aspect, a measurement processing method is provided, including:
receiving, by a second device, a first measurement report or a second measurement report, where the first measurement report is obtained by a terminal measuring a first signal, and the second measurement report is obtained by a third device measuring a second signal,
where a measurement quantity for the terminal to measure the first signal or a measurement quantity for the third device to measure the second signal includes at least one of: a sensing measurement quantity; a sensing performance evaluation index; and a sensing measurement result;
the first signal includes at least one of a sensing signal, a reference signal, a synchronization signal and a data signal sent by a serving cell of the terminal or candidate target cells;
or the second signal includes at least one of a sensing signal, a reference signal, a synchronization signal and a data signal sent by the terminal; and
the second device includes a first device, and the first device includes at least one of a sensing network function, a sensing network element and a sensing management function, or the second device is associated with the serving cell of the terminal.

In a third aspect, a measurement processing method is provided, including:
measuring, by a third device, a second signal; and
sending, by the third device, a second measurement report,
where a measurement quantity for the third device to measure the second signal includes at least one of: a sensing measurement quantity; a sensing performance evaluation index; and a sensing measurement result; and
the second signal includes at least one of a sensing signal, a reference signal, a synchronization signal and a data signal sent by a terminal.

In a fourth aspect, a measurement processing apparatus is provided, including:
a first measurement module configured to measure a first signal; and
a first sending module configured to send a first measurement report to a first device or a serving cell of a terminal,
where a measurement quantity for measuring the first signal includes at least one of:
a sensing measurement quantity;
a sensing performance evaluation index; and a sensing measurement result;
the first signal includes at least one of a sensing signal, a reference signal, a synchronization signal and a data signal sent by the serving cell of the terminal or candidate target cells; and
the first device includes at least one of a sensing network function, a sensing network element and a sensing management function.

In a fifth aspect, a measurement processing apparatus is provided, including:
a fourth receiving module configured to receive a first measurement report or a second measurement report, where the first measurement report is obtained by a terminal measuring a first signal, and the second measurement report is obtained by a third device measuring a second signal,
where a measurement quantity for the terminal to measure the first signal or a measurement quantity for the third device to measure the second signal includes at least one of: a sensing measurement quantity; a sensing performance evaluation index; and a sensing measurement result;
the first signal includes at least one of a sensing signal, a reference signal, a synchronization signal and a data signal sent by a serving cell of the terminal or candidate target cells;
or the second signal includes at least one of a sensing signal, a reference signal, a synchronization signal and a data signal sent by the terminal.

In a sixth aspect, a measurement processing apparatus is provided, including:
a second measurement module configured to measure a second signal; and
a ninth sending module configured to send a second measurement report,
where a measurement quantity for measuring the second signal includes at least one of: a sensing measurement quantity; a sensing performance evaluation index; and a sensing measurement result; and
the second signal includes at least one of a sensing signal, a reference signal, a synchronization signal and a data signal sent by a terminal.

In a seventh aspect, a communications device is provided, including: a processor, a memory, and a program or an instruction stored on the memory and executable on the processor, where the program or the instruction, when executed by the processor, implements the steps of the method according to the first aspect, the second aspect or the third aspect.

In an eighth aspect, a readable storage medium is provided, storing a program or an instruction, where the program or the instruction, when executed by a processor, implements the steps of the method according to the first aspect, the second aspect or the third aspect.

In a ninth aspect, a chip is provided, including a processor and a communication interface, where the communication interface is coupled to the processor, and the processor is configured to run a program or an instruction to implement the steps of the method according to the first aspect, the second aspect or the third aspect.

In a tenth aspect, a computer program/program product is provided, and the computer program/program product is stored in a non-volatile storage medium, and executed by at least one processor to implement the steps of the method according to the first aspect, the second aspect or the third aspect.

In an eleventh aspect, a communication system is provided, including a terminal and a network device, where the terminal is configured to implement the steps of the method according to the first aspect, and the network device is configured to implement the steps of the method according to the second aspect or the third aspect.

In an embodiment of this application, in a case of switching of a base station participating in a sensing process, the terminal may measure a first signal; and then, the terminal sends a first measurement report to a first device or a serving cell of the terminal, where a measurement quantity for the terminal to measure the first signal includes at least one of: a sensing measurement quantity; a sensing performance evaluation index; and a sensing measurement result. In this way, the serving cell of the terminal or the first device can determine whether to initiate switching according to the first measurement report fed back by the terminal, thus achieving the effect that the communication system supports sensing the cell switching process, maintaining the continuity of sensing services, and ensuring the user experience of sensing services.

### BRIEF DESCRIPTION OF THE DRAWINGS

FIG. 1 is a schematic diagram of communication and sensing integration according to an embodiment of this application;

FIG. 2 is a flowchart of a measurement processing method according to an embodiment of this application;

FIG. 3 is a flowchart of a measurement processing method according to another embodiment of this application;

FIG. 4 is a flowchart of a measurement processing method according to yet another embodiment of this application;

FIG. 5 is a schematic diagram of switching between base stations in a downlink sensing process according to an embodiment of this application;

FIG. 6 is a schematic diagram of switching between base stations in an uplink sensing process according to an embodiment of this application;

FIG. 7 is a flowchart of a measurement processing method according to embodiment 1 of this application;

FIG. 8 is a flowchart of a measurement processing method according to embodiment 2 of this application;

FIG. 9 is a flowchart of a measurement processing method according to embodiment 3 of this application;

FIG. 10 is a flowchart of a measurement processing method according to embodiment 4 of this application;

FIG. 11 is a schematic diagram of Signal to Noise Ratio (SNR) calculation of a one-dimensional graph according to an embodiment of this application;

FIG. 12 is a schematic diagram of SNR calculation of a two-dimensional graph according to an embodiment of this application;

FIG. 13 is a structural diagram of a measurement processing apparatus according to an embodiment of this application;

FIG. 14 is a schematic diagram of a measurement processing apparatus according to another embodiment of this application;

FIG. 15 is a schematic diagram of a measurement processing apparatus according to yet another embodiment of this application;

FIG. 16 is a schematic diagram of a terminal according to an embodiment of this application; and

FIG. 17 is a schematic diagram of a communication device according to an embodiment of this application.

### DETAILED DESCRIPTION

The technical solutions in the embodiments of this application will be clearly described below with reference to the drawings in the embodiments of this application. Apparently, the described embodiments are merely some rather than all of the embodiments of this application. All other embodiments obtained by those skilled in the art based on the embodiments of this application fall within the protection scope of this application.

Terms such as “first” and “second” in the description and claims of this application are used for distinguishing similar objects, instead of describing a specific order or sequence. It is to be understood that terms used in this way are exchangeable in a proper case, so that the embodiments of this application can be implemented in an order different from the order shown or described herein; and the objects distinguished by “first” and “second” are usually of the same class and do not limit the number of the objects; and for example, the number of first objects may be one or more. In addition, “and/or” in the description and claims represents at least one of the connected objects. Character “/” generally represents an “or” relationship between the associated objects.

It is worth pointing out that the technologies described in the embodiments of this application are not limited to the Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), and other systems. The terms “system” and “network” in the embodiments of this application can be usually exchanged in use. The technologies described not only can be applied to the systems and radio technologies mentioned above, but also can be applied to other systems and radio technologies. The following description provides the New Radio (NR) system for example purposes and uses NR terms in most of the following description, but these technologies can also be applied to applications outside of NR system applications, such as 6G communication systems.

For the convenience of understanding the embodiments of this application, the following technical points will be introduced first:

### I. Regarding Communication and Sensing Integration

TABLE 1
Typical sensing functions and application scenarios.
Typical sensing functions and application scenarios are as shown in Table 1.

| Communication | | |
|---|---|---|
| and sensing | | |
| category | Sensing function | Application scenario |
| Macro sensing | Weather conditions, air quality and | Meteorology, agriculture, and living |
| | the like | services |
| | Traffic flow (intersection) and | Intelligent transportation and |
| | pedestrian flow (subway entrance) | commercial services |
| | Target tracking, ranging, speed | Many application scenarios of a |
| | measurement, external contour and | traditional radar |
| | the like | |
| | Environment reconstruction | Intelligent driving and navigation |
| | | (cars/drones), smart cities |
| | | (three-dimensional (3D) maps), |
| | | network planning and optimization |
| Refined sensing | Action/posture/expression | Intelligent interaction, gaming, and |
| | recognition | smart home through smart phones |
| | Heartbeat/respiration and the like | Health and medical care |
| | Imaging, material detection, | Security check, industry, biomedicine |
| | composition analysis and the like | and the like |

Communication and sensing integration (referred to as CS integration) refers to the design of integrated communication and sensing functions through spectrum sharing and hardware sharing in the same system. The system can sense information such as location, distance, and speed while transmitting information, and detect, track, and identify target devices or events. The communication system and the sensing system complement each other, achieving overall performance improvement and bringing better service experience.

The integration of communication and a radar belongs to the typical application of communication and sensing integration (communication and sensing fusion). In the past, the radar system and the communication system were strictly distinguished due to different research objects and focus, and in most scenarios, the two systems were studied independently. In fact, the radar and communication systems are both typical ways of information sending, acquisition, processing, and exchange, and there are many similarities in their working principles, system architectures, and frequency bands. The design of communication and radar integration has great feasibility, mainly reflected in the following aspects. Firstly, both the communication system and the sensing system are based on the electromagnetic wave theory, and utilize the emission and reception of electromagnetic waves to acquire and transmit information. Secondly, both the communication system and the sensing system have structures such as antennas, transmitters, receivers and signal processors, with significant overlap in hardware resources. With the development of technology, there is an increasing overlap between the two in their operating frequency bands. In addition, there are similarities in key technologies such as signal modulation and reception detection, and waveform design. The fusion of communication and radar systems can bring many advantages, such as cost savings, reduced size, lower power consumption, improved spectrum efficiency, and reduced mutual interference, thus improving the overall performance of the system.

According to the different sensing signal sending nodes and receiving nodes, there are six basic sensing methods, as shown in FIG. 1, including:
(1) Base station echo sensing. In this sensing method, base station A sends a sensing signal and performs sensing measurement by receiving echo of the sensing signal.
(2) Radio sensing between base stations. Base station B receives a sensing signal sent by base station A and performs sensing measurement.
(3) Uplink radio sensing. Base station A receives a sensing signal sent by terminal A and performs sensing measurement.
(4) Downlink radio sensing. Terminal B receives a sensing signal sent by base station B and performs sensing measurement.
(5) Terminal echo sensing. Terminal A sends a sensing signal and performs sensing measurement by receiving echo of the sensing signal.
(6) Sidelink (SL) sensing between terminals. Terminal B receives a sensing signal sent by terminal A and performs sensing measurement.

It is worth noting that each sensing method in FIG. 1 takes one sensing signal sending node and one sensing signal receiving node as examples. In actual systems, one or more different sensing methods may be selected according to different sensing use cases and needs, and each sensing method may have one or more sending nodes and receiving nodes. The sensing targets in FIG. 1 take people and vehicles as examples, and assume that neither people and vehicles carry or install signal receiving/transmitting devices. The sensing targets in actual scenarios may be more diverse.

### II: Regarding Handover

Handover is triggered by the movement of the terminal in a connected state, and the basic purposes of handover are to indicate that the terminal can communicate with a cell with better channel quality than the existing serving cell; and provide continuous uninterrupted communication services for the terminal, so as to effectively prevent call drops caused by worsened signal quality of the cell.

The handover process in 5G includes the following steps (basically similar to that in LTE):

In step 1, measurement is triggered. After the terminal completes the access or the handover succeeds, the base station will send measurement control information to the terminal through Radio Resource Control (RRC) connection reconfiguration. In addition, in a case that the measurement configuration information is updated, the base station will also send updated measurement control information through an RRC connection reconfiguration message. The most important content in the measurement control information includes measurement object issuance, Measurement Report (MR) configuration and measurement event.

In step 2, measurement is performed. According to the relevant configuration of measurement control, the terminal monitors a wireless channel. When a measurement reporting condition is satisfied, the terminal reports to the base station through an event. For the trigger of the number of measurement report/event, a reference may be made to Reference Signal Received Power (RSRP), Reference Signal Received Quality (RSRQ), or Signal to Interference plus Noise Ratio (SINR).

In step 3, a target is decided. The base station uses measurement as its basic resource and selects a handover cell based on the principle of reporting first and processing first, and chooses a corresponding handover strategy (such as handover and redirection).

In step 4, handover is performed. The source base station applies for and allocates resources to the target base station. Then, the source base station makes a handover execution decision and sends a handover command to the terminal. The terminal performs handover and data forwarding.

The terminal involved in this application may be a terminal-side device such as a mobile phone, a tablet personal computer, a laptop computer also called a notebook computer, a Personal Digital Assistant (PDA), a hand-held computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart home (home devices with wireless communication functions, such as refrigerators, televisions, washing machines, or furniture), a game console, a Personal Computer (PC), an ATM or a self-service machine. The wearable device includes a smart watch, a smart wristlet, a smart headphone, smart glasses, smart jewelry (a smart bangle, a smart bracelet, a smart ring, a smart necklace, a smart ankle bangle, a smart anklet and the like), a smart wristband, smart clothing and a game console. It is to be understood that the type of the terminal is not limited in the embodiments of this application.

A first device involved in this application may also be referred to as a sensing network function, a sensing network element, or a Sensing Management Function (MF). The first device may be located on a Radio Access Network (RAN) side (that is, the first device may be an RAN device) or a core network side (that is, the first device may be a core network device), referring to a network node in the core network and/or RAN responsible for at least one function of sensing request processing, sensing resource scheduling, sensing information exchange and sensing data processing and the like. The first device may be an upgrade based on the existing 5G network's Access and Mobility Management Function (AMF) or Location Management Function (LMF), or the first device may be other network nodes or a newly defined network node.

The core network device involved in this application may include, but not limited to, at least one of: a core network node, a core network function, a Mobility Management Entity (MME), an AMF, an LMF, a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Warehouse (UDR), a Home Subscription Server (HSS), Centralized Network Configuration (CNC), a Network Storage Function (NRF), a Network Exposure Function (NEF), a Local NEF (L-NEF), a Binding Support Function (BSF) and an Application Function (AF). It is to be understood that description is made by using only a core network device in an NR system as an example in the embodiments of this application, but the type of the core network device is not limited.

The sensing signal involved in this application may be a signal with only sensing function and no communication function, such as an existing LTE/NR synchronization signal or a reference signal, and such a signal is based on a pseudo-random sequence, including one of an m sequence, a Zadoff-Chu sequence, a Gold sequence and the like. In some alternative embodiments, the sensing signal may also be a single frequency Continuous Wave (CW), a Frequency Modulated CW (FMCW), an ultrawideband Gaussian pulse and the like commonly used in radar. In some alternative embodiments, the sensing signal may also be a newly designed dedicated sensing signal with good correlation characteristics and a low Peak to Average Power Ratio (PAPR), or a newly designed CS integration signal with both sensing and communication functions. In the embodiments of this application, the sensing signal or CS integration signal is uniformly referred to as a sensing signal.

A measurement processing method and apparatus, a communication device and a readable storage medium provided in the embodiments of this application will be described below in detail through some embodiments and application scenarios with reference to the drawings.

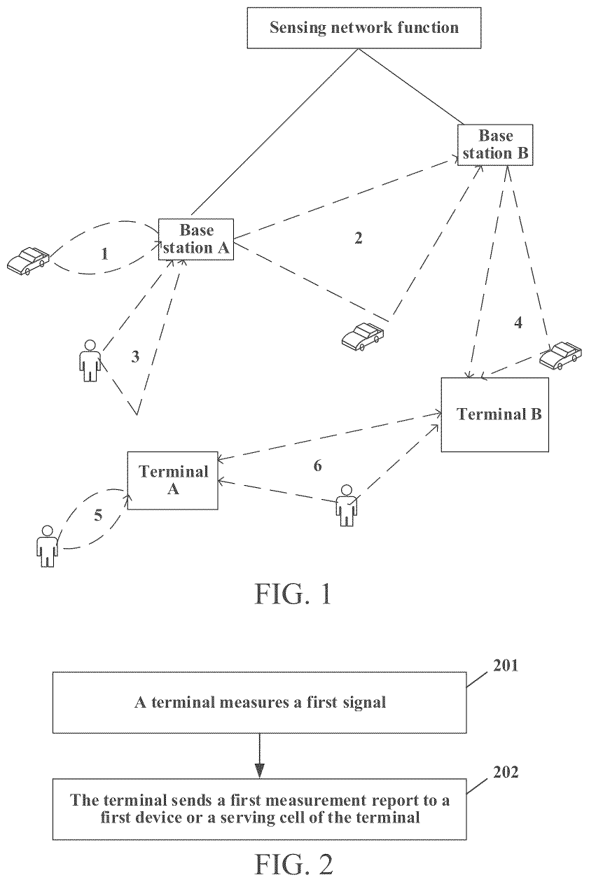

Referring to FIG. 2, an embodiment of this application provides a measurement processing method applied to a terminal, including the following steps:

In step 201, a terminal measures a first signal.

For example, in a case of switching of a node performing sensing (or described as a node participating in a sensing process), the terminal measures the first signal.

The above case of switching of a node performing sensing includes one of the following: (1) the movement of a sensing target leads to switching of the node performing sensing; (2) the movement of a sensing signal receiving end leads to switching of the node performing sensing; and (3) the movement of a sensing signal sending end leads to switching of the node performing sensing.

In step 202, the terminal sends a first measurement report to a first device or a serving cell of the terminal,
where a measurement quantity for the terminal to measure the first signal includes at least one of:
(1) a sensing measurement quantity;
in some embodiments, the sensing measurement quantity required for measurement may include a sensing measurement quantity for a current sensing service.

In some embodiments, the sensing measurement quantity includes at least one of:
a) a first-level measurement quantity (received signal/original channel information), including at least one of received signal/channel response complex results, an amplitude/phase, I/Q channels and results of their operations (including addition, subtraction, multiplication and division, matrix addition, subtraction and multiplication, matrix transposition, trigonometric relationship operation, square root operation and power operation, as well as threshold detection results and maximum/minimum value extraction results of the above results of operations, where the operations further include Fast Fourier Transform (FFT)/Inverse Fast Fourier Transform (IFFT), Discrete Fourier Transform (DFT)/Inverse Discrete Fourier Transform (IDFT), Two Dimensions Fast Fourier Transform (2D-FFT), Three Dimensions Fast Fourier Transform (3D-FFT), matched filtering, autocorrelation operation, wavelet transform, and digital filtering, as well as threshold detection results and maximum/minimum value extraction results of the above results of operations);
b) a second-level measurement quantity (a basic measurement quantity), including at least one of a delay, a Doppler, an angle, an intensity and multidimensional combination representations thereof;
c) a third-level measurement quantity (a basic attribute/state), including at least one of a distance, a speed, an orientation, a spatial position and an acceleration; and
d) a fourth-level measurement quantity (an advanced attribute/state), including at least one of target existence or non-existence, a trajectory, an action, an expression, vital signs, a quantity, an imaging result, a weather, an air quality, a shape, a material, and a composition.

In some embodiments, the above sensing measurement quantity further includes at least one of:
e) corresponding label information;
f) identity information of a sensing signal;
g) sensing measurement configuration identity information;
h) sensing service information, such as a sensing service Identity (ID);
i) a data subscription ID;
j) measurement quantity purposes, such as communication, sensing, and CS;
k) time information;
l) sensing node information, such as a terminal ID, a node location, and a device orientation;
m) sensing link information, such as a sensing link sequence number and a transmitter/receiver node identity;
n) measurement quantity description information, such as an amplitude, a phase and a complex, and resource information such as an antenna/antenna pair/antenna group, a PRB, and a symbol; and
o) measurement quantity index information, such as a Signal to Noise Ratio (SNR) and a sensing SNR.
(2) a sensing performance evaluation index; and
(3) a sensing measurement result, for example, including a sensing result obtained directly or indirectly based on at least one sensing measurement quantity.

In some embodiments, the sensing performance evaluation index includes at least one of:
(a) a sensing SNR, i.e., ratio of sensing signal energy reflected by a sensing object or sensing area to noise signal energy in an environment and device;
(b) a sensing SINR, i.e., ratio of sensing signal energy reflected by a sensing object or sensing area to a sum of interference signal energy and noise signal energy in an environment and device;
(c) a statistical mean, a standard deviation, or a variance of multiple measurement results of the same sensing measurement quantity;
(d) a deviation between a predicted value and an actual value of a sensing measurement quantity/sensing result, and a statistical mean, a standard deviation, or a variance of the deviation;
(c) a sensing repetition evaluation index (such as a sum of Euclidean distances between sampling points of two sequences, or a regular path distance in Dynamic Time Warping (DTW), or other indexes reflecting the similarity between two sequences, including, but not limited to, a Longest Common Subsequence (LCSS), an Edit Distance on Real Sequence (EDR), an Edit Distance with Real Penalty (ERP), a Hausdorff distance, a Fréchet distance, a One Way Distance (OWD) and a Locality In-between Polylines (LIP));
(f) an echo signal power, such as an echo signal power of a first signal.

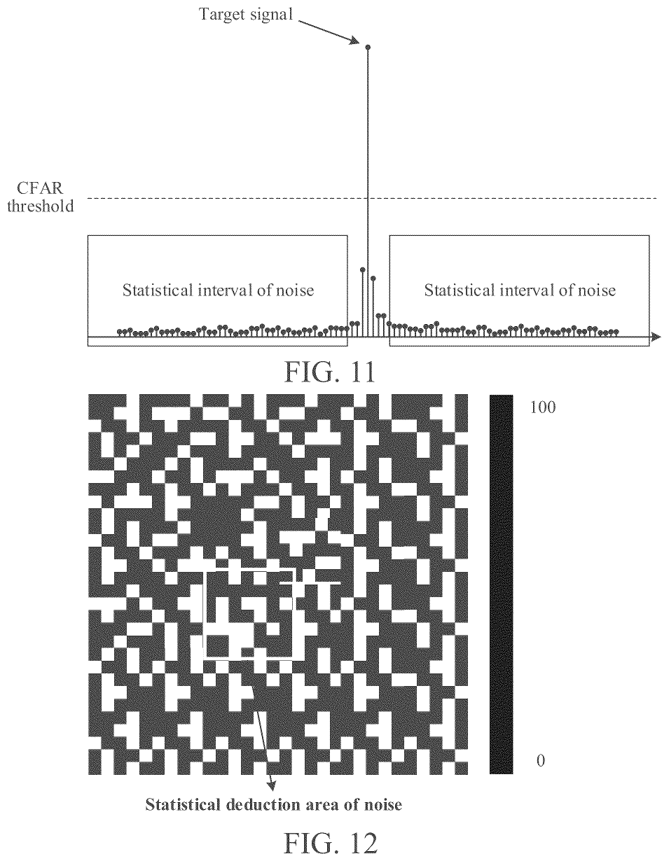

The method for obtaining the echo signal power may be at least one of the following:
(1) a Constant False-Alarm Rate (CFAR) is performed based on a delay one-dimensional graph obtained through the FFT processing of the echo signal in a fast time dimension, and the echo signal power is calculated by taking the sample point with the maximum amplitude exceeding the threshold of the CFAR as the target sample point and its amplitude as the target signal amplitude, as shown in FIG. 11;
(2) a CFAR is performed based on a Doppler one-dimensional graph obtained through the FFT processing of the echo signal in a slow time dimension, and the echo signal power is calculated by taking the sample point with the maximum amplitude exceeding the threshold of the CFAR as the target sample point and its amplitude as the target signal amplitude, as shown in FIG. 11;
(3) a CFAR is performed based on a delay-Doppler two-dimensional graph obtained through the 2D-FFT processing of the echo signal, and the echo signal power is calculated by taking the sample point with the maximum amplitude exceeding the threshold of the CFAR as the target sample point and its amplitude as the target signal amplitude, as shown in FIG. 12;
(4) a CFAR is performed based on a delay-Doppler-angle three-dimensional graph obtained through the 3D-FFT processing of the echo signal, and the echo signal power is calculated by taking the sample point with the maximum amplitude exceeding the threshold of the CFAR as the target sample point and its amplitude as the target signal amplitude; and
(5) the method for determining the target signal amplitude, in addition to using the sample point with the maximum amplitude exceeding the threshold of the CFAR as the target sample point, may be that the echo signal power is calculated by taking the average of the sample point with the maximum amplitude exceeding the threshold of the CFAR and several closest sample points that exceed the threshold as the target signal amplitude.

In an implementation of this application, the method for obtaining the sensing SNR and sensing SINR may be as follows:
(1) a CFAR is performed based on a delay one-dimensional graph obtained through the FFT processing of the echo signal in a fast time dimension, the sample point with the maximum amplitude exceeding the threshold of the CFAR is taken as the target sample point, its amplitude is taken as the target signal amplitude, all sample points being ±ε sample points away from the position of the target sample point in the one-dimensional graph are taken as the interference/noise sample points, the average interference/amplitude is statistically calculated as the interference/noise signal amplitude, as shown in FIG. 11, and finally, SNR/SINR is calculated based on the target signal amplitude and the interference/noise signal amplitude;
(2) a CFAR is performed based on a Doppler one-dimensional graph obtained through the FFT processing of the echo signal in a slow time dimension, the sample point with the maximum amplitude exceeding the threshold of the CFAR is taken as the target sample point, its amplitude is taken as the target signal amplitude, all sample points being ±η sample points away from the position of the target sample point in the one-dimensional graph are taken as the interference/noise sample points, the average amplitude is statistically calculated as the interference/noise signal amplitude, and finally, SNR/SINR is calculated based on the target signal amplitude and the interference/noise signal amplitude;
(3) a CFAR is performed based on a delay-Doppler two-dimensional graph obtained through the 2D-FFT processing of the echo signal, the sample point with the maximum amplitude exceeding the threshold of the CFAR is taken as the target sample point, its amplitude is taken as the target signal amplitude, all sample points being ±ε (fast time dimension) and ±η (slow time dimension) sample points away from the target sample point in the two-dimensional graph are taken as the interference/noise sample points, the average amplitude is statistically calculated as the interference/noise signal amplitude, as shown in FIG. 12, and finally, SNR/SINR is calculated based on the target signal amplitude and the interference/noise signal amplitude; and
(4) a CFAR is performed based on a delay-Doppler-angle three-dimensional graph obtained through the 3D-FFT processing of the echo signal, the sample point with the maximum amplitude exceeding the threshold of the CFAR is taken as the target sample point, its amplitude is taken as the target signal amplitude, all sample points being ±ε (fast time dimension), ±η (slow time dimension) and ±δ (angle dimension) sample points away from the target sample point in the three-dimensional graph are taken as the interference/noise sample points, the average amplitude is statistically calculated as the interference/noise signal amplitude, and finally, SNR/SINR is calculated based on the target signal amplitude and the interference/noise signal amplitude.

The method for determining the target signal amplitude, in addition to using the sample point with the maximum amplitude exceeding the threshold of the CFAR as the target sample point, may be that the average of the sample point with the maximum amplitude exceeding the threshold of the CFAR and several closest sample points that exceed the threshold as the target signal amplitude.

The method for determining the interference/noise signal amplitude may also be that further screening is performed based on the interference/noise sample points determined above. The screening method is as follows: for a delay one-dimensional graph, several sample points close to a delay of zero are removed and the remaining interference/noise sample points are taken as the noise sample points; for a Doppler one-dimensional graph, several sample points close to a Doppler of zero are removed and the remaining interference/noise sample points are taken as the interference/noise sample points; for a delay-Doppler two-dimensional graph, several sample points close to a delay of zero and the interference/noise sample points in a strip-shaped range composed of the entire Doppler range are removed, and the remaining noise sample points are taken as the interference/noise sample points; and for a delay-Doppler-angle two-dimensional graph, several sample points close to a delay of zero and the interference/noise sample points in a slice-shaped range composed of the entire Doppler range and the entire angle range are removed, and the remaining interference/noise signal amplitudes are taken as the interference/noise sample points.

It is worth noting that the first measurement report includes a measurement result of the measurement quantity for the terminal to measure the first signal.

In some embodiments, the measurement quantity for the terminal to measure the first signal further includes at least one of:
(4) a RSRP;
(5) a RSRQ;
(6) an SINR; and
(7) a Received Signal Strength Indicator (RSSI).

In some embodiments, the first signal includes at least one of a sensing signal, a reference signal, a synchronization signal and a data signal sent by the serving cell of the terminal or candidate target cells.

In an implementation of this application, the first device includes at least one of a sensing network function, a sensing network element and a sensing management function.

In this embodiment, the node performing sensing before switching may be referred to as the source sensing node (the source node or the source base station and the like), the cell performing sensing after switching may be referred to as the target sensing node (the target node or the target base station and the like), and the above terminal is referred to as the terminal performing sensing.

In an implementation of this application, before the terminal measures the first signal, the method further includes the following step:
the terminal receives first measurement configuration information,
where the first measurement configuration information includes at least one of:
(1) a measurement object, including configuration information of the first signal,
such as parameter information (such as a subcarrier interval) of one or more first signals required to be sent by the serving cell (such as the source sensing node) and candidate target cell (such as the candidate target sensing node) of the terminal that the terminal needs to measure, and/or information of signal resources (such as a time resource and a frequency resource);
(2) measurement report configuration information, including at least one or more of: (a) a reporting method (or a principle of reporting), such as periodic reporting or measurement event triggered reporting; (b) a measurement content to be reported by the terminal, including at least one of: a communication index, a sensing performance evaluation index, a sensing measurement quantity and a sensing result; (c) a type of a reference signal for measurement; and (d) a format of a measurement report, such as the maximum number of reported cells and the number of beams; and
(3) a measurement ID, where a measurement identity is used for associating at least one measurement object with at least one piece of switching measurement report configuration information, that is, the measurement ID is used for associating the measurement object with the measurement report configuration information.

In a case that the above reporting method includes the measurement event triggered reporting, the first measurement configuration information further includes (4) a first measurement event.

In some embodiments, the first measurement event includes at least one of the following:
(4.1) The sensing performance evaluation index of at least one candidate target cell and/or the serving cell satisfies a first preset condition.

For example, the sensing performance evaluation index of the first signal sent by the candidate target cell measured by the UE remains at or above a preset threshold within a preset time period, or exceeds the preset threshold for a preset number of times within the preset time period. For another example, the sensing performance evaluation index of the first signal sent by the candidate target cell is superior to the sensing performance evaluation index of the first signal sent by the serving cell within a preset time period, or exceeds the sensing performance evaluation index of the first signal sent by the serving cell of the terminal for a preset number of times within the preset time period. For another example, the sensing performance evaluation index of the first signal sent by the candidate target cell is superior to a first threshold within a preset time period, and the sensing performance evaluation index of the first signal sent by the serving cell is inferior to a second threshold within the preset time period.
(4.2) The sensing measurement quantity for at least one candidate target cell and/or the serving cell satisfies a second preset condition.

For example, the sensing measurement quantity for the first signal sent by the candidate target cell measured by the UE remains at or above a preset threshold within a preset time period, or exceeds the preset threshold for a preset number of times within the preset time period. For another example, the sensing measurement quantity for the first signal sent by the candidate target cell is superior to the sensing measurement quantity for the first signal sent by the serving cell within a preset time period, or exceeds the sensing measurement quantity for the first signal sent by the serving cell of the terminal for a preset number of times within the preset time period. For another example, the sensing measurement quantity for the candidate target cell is superior to a third threshold, and the sensing measurement quantity for the serving cell is inferior to a fourth threshold.
(4.3) The sensing result of at least one candidate target cell and/or the serving cell satisfies a third preset condition within a preset time period.

For example, the sensing result of the first signal sent by the candidate target cell measured by the UE is superior to the sensing result of the first signal sent by the serving cell within a preset time period.

In some embodiments, the sensing result includes at least one of: the shape of the sensing target; 2D/3D environment reconstruction of the sensing target; the spatial position of the sensing target; the orientation of the sensing target; the displacement of the sensing target; the moving speed of the sensing target; the acceleration of the sensing target; speed measurement, distance measurement, angle measurement/imaging of the target object in radar sensing; human/thing existence or non-existence; the sensing target, such as a human action, a gesture, a respiratory rate, a heart rate and a sleep quality.
(4.4) Parameter information of the first signal (such as parameter information of the sensing signal) sent by at least one candidate target cell satisfies a sensing Quality of Service (QoS) minimum configuration requirement.

In some embodiments, the sensing QoS includes a performance index for sensing the sensing target area or the sensing object.

In some embodiments, the performance index includes at least one of:
(a) a sensing resolution,
where the sensing resolution includes at least one of a distance measurement resolution, an angle measurement resolution, a speed measurement resolution, an imaging resolution and the like;
(b) a sensing accuracy,
where the sensing accuracy includes at least one of a distance measurement accuracy, an angle measurement accuracy, a speed measurement accuracy, a positioning accuracy and the like;
(c) a sensing range,
where the sensing range includes at least one of a distance measurement range, a speed measurement range, an angle measurement range, an imaging range and the like;
(d) a sensing delay,
where the sensing delay includes a time interval from the sending of the sensing signal to the obtaining of the sensing result, or a time interval from the initiation of the sensing demand to the obtaining of the sensing result;
(e) a sensing update rate, referring to a time interval between two adjacent times of sensing and obtaining the sensing result;
(f) a detection probability, referring to the probability of being correctly detected in the presence of a sensing object; and
(g) a misdetection probability, referring to the probability of detecting a sensing target incorrectly in a case that a sensing object does not exist.
(4.5) A state of a sensing target changes.

The state includes a position and a speed.
(4.6) A position of the terminal participating in sensing changes.
(4.7) A communication related index of at least one candidate target cell and/or the serving cell satisfies a fourth preset condition.

The communication related index includes at least one of an RSRP, an SINR, an RSRQ, an RSSI and the like. For example, the communication related index of the candidate target cell is superior to the communication related index of the serving cell of the terminal within a preset time period.

It is to be understood that to determine whether the first measurement event is satisfied, the average value of multiple measurement quantities/indexes at different times (layer 1 filtering and/or layer 3 filtering) may be used to avoid the randomness/ping-pong effect caused by determination according to a single result.

Multiple first signals may correspond to multiple transmitting/receiving beam pairs, and whether a measurement event is satisfied may be determined according to the measurement quantity/index of one or more beams.

In an implementation of this application, the method further includes the following step:
the terminal receives second indicator information, where the second indicator information is used for indicating that the serving cell no longer participates in sensing after switching is completed; or
the terminal receives third indicator information (or referred to as sensing end command), where the third indicator information is used for indicating that sensing related to the serving cell ends.

In an implementation of this application, after the terminal sends the first measurement report, the method further includes the following steps:
the terminal receives configuration information sent by the serving cell, where the configuration information includes at least one of a cell identity of a target cell and random access channel information; and
the terminal initiates random access to the target cell.

In an embodiment of this application, in a case of switching of a base station participating in a sensing process, the terminal may measure a first signal; and then, the terminal sends a first measurement report, where a measurement quantity for the terminal to measure the first signal includes at least one of: a sensing measurement quantity; a sensing performance evaluation index; and a sensing measurement result. In this way, the serving cell of the terminal or the first device can determine whether to initiate switching according to the first measurement report fed back by the terminal, thus achieving the effect that the communication system supports sensing the cell switching process, maintaining the continuity of sensing services, and ensuring the user experience of sensing services.

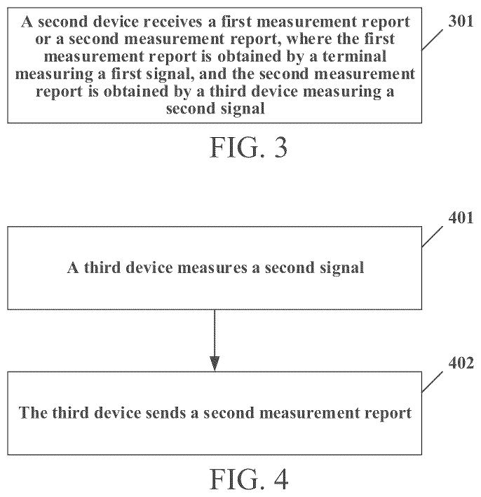

Referring to FIG. 3, an embodiment of this application provides a measurement processing method applied to a second device. The second device includes a first device. The first device includes at least one of a sensing network function, a sensing network element and a sensing management function, or the second device is associated with the serving cell of the terminal. For example, the second device is a base station of a serving cell of the terminal. The method includes step 301.

In step 301, a second device receives a first measurement report or a second measurement report, where the first measurement report is obtained by a terminal measuring a first signal, and the second measurement report is obtained by a third device measuring a second signal,
where a measurement quantity for the terminal to measure the first signal or a measurement quantity for the third device to measure the second signal includes at least one of: (1) a sensing measurement quantity; (2) a sensing performance evaluation index; and (3) a sensing measurement result.

In an implementation of this application, the measurement quantity for the terminal to measure the first signal or the measurement quantity for the third device to measure the second signal further includes at least one of: (4) an RSRP; (5) an RSRQ; (6) an SINR; and (7) an RSSI.

In some embodiments, the first signal includes at least one of a sensing signal, a reference signal, a synchronization signal and a data signal sent by the serving cell of the terminal or candidate target cells.

In some embodiments, the second signal includes at least one of a sensing signal, a reference signal, a synchronization signal and a data signal sent by the terminal.

In an implementation of this application, in a case that the second device is the first device, the second device receives a switching measurement report from the terminal or the serving cell.

In another implementation of this application, the second device is associated with the serving cell of the terminal. For example, in a case that the second device is the base station of the serving cell of the terminal, the second device receives a switching measurement report from the terminal or the first device.

In an implementation of this application, the method further includes the following steps:
the second device determines whether to initiate switching according to the first measurement report or the second measurement report, for example, determines whether to initiate switching of a sensing node; and
the second device determines at least one candidate target cell performing sensing in a case that it is determined to initiate switching.

In an implementation of this application, the process that the second device determines at least one candidate target cell performing sensing includes the following step:
the second device determines at least one candidate target cell performing sensing according to first information,
where the first information includes at least one of:
(1) position information of candidate target cells;
(2) orientation information of antenna panels of candidate target cells;
(3) sensing capability information of candidate target cells;
in some embodiments, the sensing capability information of the candidate target cells includes at least one of a sensing coverage range, a maximum bandwidth available for sensing, a maximum sustainable time for sensing services, supported types and frame formats of sensing signals and antenna array information, such as an array type, the number of antennas, an array aperture, antenna polarization characteristics, an element gain and directional characteristics;
(4) information of resources of candidate target cells available for sensing at present;
in some embodiments, the information of the resources of the candidate target cells available for sensing at present includes at least one of time resources (such as the numbers of symbols, slots and frames), frequency resources (such as the numbers of Resource Blocks (RBs) and Resource Elements (REs), a total bandwidth, and available frequency band positions), antenna resources (such as the numbers of antennas or antenna subarrays), phase modulation resources (such as the number of hardware phase shifters) and orthogonal code resources (such as the length and number of orthogonal codes); and
(5) channel state information of candidate target cells.

In some embodiments, the channel state information of the candidate target cells includes at least one of a channel transfer function/channel impulse response of at least one communication link, a Channel Quality Indicator (CQI), a Precoding Matrix Indicator (PMI), a Channel State Information Reference Signal (CSI-RS) resource indicator, an SSB resource indicator, a Layer Indicator (LI), a Rank Indicator (RI) and a Layer 1 Reference Signal Received Power (L1-RSRP).

In an implementation of this application, the method further includes the following step:
the second device sends first request information to at least one candidate target cell, where the first request information is used for requesting at least one candidate target cell to perform sensing; and
where the first request information includes at least one of:
(1) a soft handover request;
(2) a sensing demand;
in some embodiments, the sensing demand includes at least one of a sensing target area, referring to a possible location area of the sensing object, or a location area requiring imaging or three-dimensional reconstruction; a sensing object type, where sensing objects are classified based on their possible movement characteristics, and each sensing object type contains information such as a moving speed, a moving acceleration, and typical Radar Cross Section (RCS) of the typical sensing object; a sensing QoS; a required sensing function; a sensing purpose; and a sensing result.
(3) a sensing QoS;
in some embodiments, the sensing QoS refers to a performance index for sensing the sensing target area or the sensing object; and in some embodiments, the sensing QoS includes at least one of a sensing resolution (such as a distance measurement resolution, an angle measurement resolution, a speed measurement resolution and an imaging resolution), a sensing accuracy (such as a distance measurement accuracy, an angle measurement accuracy, a speed measurement accuracy and a positioning accuracy), a sensing range (such as a distance measurement range, a speed measurement range, an angle measurement range and an imaging range), a sensing delay (such as the time interval from the sending of the sensing signal to the obtaining of the sensing result, or the time interval from the initiation of the sensing demand to the obtaining of the sensing result), a sensing update rate (such as the time interval between adjacent two times of sensing and obtaining the sensing result), a detection probability (such as the probability of correctly detecting the sensing target in the presence of the sensing object), a misdetection probability (such as the probability of incorrectly detecting the sensing target in the absence of the sensing object), a sensing security, and a sensing privacy.
(4) a sensing measurement quantity;
in some embodiments, the sensing measurement quantity includes at least one of:
a) a first-level measurement quantity (received signal/original channel information), including at least one of received signal/channel response complex results, an amplitude/phase, I/Q channels and results of their operations (including addition, subtraction, multiplication and division, matrix addition, subtraction and multiplication, matrix transposition, trigonometric relationship operation, square root operation and power operation, as well as threshold detection results and maximum/minimum value extraction results of the above results of operations, where the operations further include FFT/Inverse Fast Fourier Transform (IFFT), DFT/IDFT, 2D-FFT, 3D-FFT, matched filtering, autocorrelation operation, wavelet transform, and digital filtering, as well as threshold detection results and maximum/minimum value extraction results of the above results of operations);
b) a second-level measurement quantity (a basic measurement quantity), including at least one of a delay, a Doppler, an angle, an intensity and multidimensional combination representations thereof;
c) a third-level measurement quantity (a basic attribute/state), including at least one of a distance, a speed, an orientation, a spatial position and an acceleration; and
d) a fourth-level measurement quantity (an advanced attribute/state), including at least one of target existence or non-existence, a trajectory, an action, an expression, vital signs, a quantity, an imaging result, a weather, an air quality, a shape, a material, and a composition.

In some embodiments, the above sensing measurement quantity further includes at least one of:
e) corresponding label information;
f) identity information of a sensing signal;
g) sensing measurement configuration identity information;
h) sensing service information, such as a sensing service ID;
i) a data subscription ID;
j) measurement quantity purposes, such as communication, sensing, and CS;
k) time information;
l) sensing node information, such as a terminal ID, a node location, and a device orientation;
m) sensing link information, such as a sensing link sequence number and a transmitter/receiver node identity;
n) measurement quantity description information, such as an amplitude, a phase and a complex, and resource information such as an antenna/antenna pair/antenna group, a PRB, and a symbol; and
o) measurement quantity index information, such as a SNR and a sensing SNR.
(5) a sensing measurement result;
in some embodiments, the sensing measurement result includes a sensing result obtained directly or indirectly based on at least one sensing measurement quantity.
(6) a sensing condition;
in some embodiments, the sensing condition includes at least one of a sensing start time, a sensing end time, a sensing duration and the like.
(7) sensing target or sensing area prior information;
in some embodiments, the sensing target or sensing area prior information includes the type of the sensing target, the approximate location/area where the sensing target is located, and the historical state of the sensing target (such as at least one of a speed, an angle, a distance, an acceleration, a spatial orientation and the like).
(8) a decision condition for deciding that sensing mode switching succeeds.

In some embodiments, the decision condition for deciding that sensing mode switching succeeds is used for indicating that a measurement result of at least one sensing measurement quantity and/or communication measurement quantity reaches a preset threshold within preset time/preset times.

In an implementation of this application, the method further includes the following step:
the second device sends first indicator information to the serving cell, where the second device is the first device.

In another implementation of this application, the method further includes the following step:
the second device sends first indicator information to the first device, where the second device is associated with the serving cell of the terminal,
where the first indicator information is used for indicating that at least one candidate target cell performs sensing.

In an implementation of this application, the method further includes the following step:
the second device sends second indicator information to the terminal, where the second indicator information is used for indicating that the serving cell no longer participates in sensing after switching is completed.

In an implementation of this application, the method further includes the following step:
the second device receives first refusal information, where the first refusal information is used for indicating that a device which sends the first refusal information does not perform sensing.

In an implementation of this application, the method further includes the following step:
the second device receives first response information, where the first response information is used for indicating that a device which sends the first response information agrees to perform sensing.

In an implementation of this application, the method further includes the following steps:
the second device determines at least one target cell of the candidate target cells as a cell performing sensing after switching according to the first response information; and
the second device sends a switching command to the target cell, where the switching command includes second parameter configuration information, where the second parameter configuration information includes at least one of parameter information of the first signal or the second signal, resource information of the first signal or the second signal and soft handover parameter configuration information.

In an implementation of this application, the first response information includes first parameter configuration information, where the first parameter configuration information includes at least one of parameter information of the first signal or the second signal and resource information of the first signal or the second signal.

The resource information of the first signal or the second signal may include at least one of:
a) a time resource, such as a slot index of a slot where the sensing signal is located or a symbol index of the slot,
where the time resource may be divided into two types, one type is a disposable time resource, for example, one symbol sends an omnidirectional first signal/second signal; and the other type is a non-disposable time resource, such as multiple sets of periodic time resources or discontinuous time resources (the non-disposable time resource may include a start time and an end time), each set of periodic time resources sends sensing signals in the same direction, and the beam directions on different sets of periodic time resources are different; and
b) a frequency resource, where the frequency resource includes at least one of a center frequency, a bandwidth, a RB, subcarrier and the like of the first signal or the second signal.

In an implementation of this application, in a case that the first request information includes a soft handover request and the candidate target cell agrees and supports soft handover, the first parameter configuration information further includes soft handover parameter configuration information.

In an implementation of this application, the method further includes the following step:
after the second device receives a switching success message from the target cell, the second device sends third indicator information to the terminal.

In another implementation of this application, the second device sends third indicator information (i.e., a sensing end command) to the terminal,
where the third indicator information is used for indicating that sensing related to the serving cell ends.

In an implementation of this application, the method further includes the following step:
the second device sends second information to the target cell, where the second information includes at least one of:
(1) part or all of historical sensing measurement quantities;
(2) part or all of historical sensing results; and
(3) sensing target or sensing area prior information.

In an implementation of this application, the method further includes the following step:
the second device sends first measurement configuration information or second measurement configuration information,
where the first measurement configuration information or the second measurement configuration information includes at least one of:
(1) a measurement object, including configuration information of the first signal or the second signal;
(2) measurement report configuration information, including at least one of a reporting method, the type of a reference signal for measurement and the format of a measurement report; and
(3) a measurement identity, where a measurement identity is used for associating at least one measurement object with at least one measurement report configuration.

In an implementation of this application, the reporting method includes periodic reporting or measurement event triggered reporting; and
in a case that the reporting method includes the measurement event triggered reporting, the first measurement configuration information further includes (4a) a first measurement event or the second measurement configuration information further includes (4b) a second measurement event.

In an implementation of this application, the first measurement event includes at least one of the following:
(4a.1) the sensing performance evaluation index of at least one candidate target cell and/or the serving cell satisfies a first preset condition;
(4a.2) the sensing measurement quantity for at least one candidate target cell and/or the serving cell satisfies a second preset condition;
(4a.3) the sensing result of at least one candidate target cell and/or the serving cell satisfies a third preset condition within a preset time period;
(4a.4) parameter information of the first signal sent by at least one candidate target cell satisfies a sensing QoS minimum configuration requirement;
(4a.5) a state of a sensing target changes;
(4a.6) a position of the terminal changes; and
(4a.7) a communication related index of at least one candidate target cell and/or the serving cell satisfies a fourth preset condition.

For the description of the above (4a.1) to (4a.7), a reference may be made to (4.1) to (4.7), and the description will not be repeated here.

In an implementation of this application, the second measurement event includes at least one of the following:
(4b.1) a sensing performance evaluation index of the second signal satisfies a fifth preset condition;
for example, the sensing performance evaluation index of the second signal measured by the candidate target cell remains at or above a preset threshold within a preset time period, or exceeds the preset threshold for a preset number of times within the preset time period. For another example, the sensing performance evaluation index of the second signal measured by the candidate target cell is superior to the sensing performance evaluation index of the second signal measured by the serving cell within a preset time period, or exceeds the sensing performance evaluation index of the second signal measured by the serving cell for a preset number of times within the preset time period.
(4b.2) a sensing measurement quantity for the second signal satisfies a sixth preset condition;
for example, the sensing measurement quantity for the second signal measured by the candidate target cell the remains at or above a preset threshold within a preset time period, or exceeds the preset threshold for a preset number of times within the preset time period. For another example, the sensing measurement quantity for the second signal measured by the candidate target cell is superior to the sensing measurement quantity for the second signal measured by the serving cell within a preset time period, or exceeds the sensing measurement quantity for the second signal measured by the serving cell for a preset number of times within the preset time period.
(4b.3) a sensing result of the second signal satisfies a seventh preset condition within a preset time period;
for example, the sensing result of the second signal measured by the candidate target cell is superior to the sensing result of the serving cell within a preset time period.
(4b.4) parameter information of the second signal estimated by at least one candidate target cell satisfies a sensing QoS minimum configuration requirement;
(4b.5) a state of a sensing target changes;
(4b.6) a position of the terminal changes; and
(4b.7) a communication related index of the second signal satisfies an eighth preset condition.

The communication related index includes at least one of an RSRP, an SINR, an RSRQ, an RSSI and the like. For example, the communication related index of the candidate target cell is superior to the communication related index of the serving cell within a preset time period.

In an embodiment of this application, in a case that the base station participating in the sensing process is switched, a second device may receive a first measurement report or a second measurement report, where the first measurement report is obtained by a terminal measuring a first signal, and the second measurement report is obtained by a third device measuring a second signal; the terminal may measure the first signal; and the first measurement report or the second measurement report is used for determining whether to initiate switching, thus achieving the effect that the communication system supports sensing the cell switching process, maintaining the continuity of sensing services, and ensuring the user experience of sensing services.

Referring to FIG. 4, an embodiment of this application provides a measurement processing method applied to a third device, including step 401 and step 402.

In step 401, a third device measures a second signal.

In step 402, the third device sends a second measurement report.

For example, the third device sends the second measurement report to the serving cell of the terminal.

A measurement quantity for the third device to measure the second signal includes at least one of: a sensing measurement quantity; a sensing performance evaluation index; and a sensing measurement result.

In some embodiments, the second signal includes at least one of a sensing signal, a reference signal, a synchronization signal and a data signal sent by the terminal.

In an implementation of this application, the first request information includes at least one of:
(1) a soft handover request;
(2) a sensing demand;
(3) a sensing QOS;
(4) a sensing measurement quantity;
(5) a sensing measurement result;
(6) a sensing condition;
(7) sensing target or sensing area prior information; and
(8) a decision condition for deciding that sensing mode switching succeeds.

In an implementation of this application, the method further includes the following step:
the third device sends first response information to the second device in a case that the third device determines to accept the switching or perform sensing, where the first response information is used for indicating that a device which sends the first response information agrees to perform sensing,
where the first response information includes first parameter configuration information; and the first parameter configuration information includes at least one of parameter information of the second signal and resource information of the second signal.

In an implementation of this application, in a case that the first request information includes a soft handover request and the candidate target cell agrees and supports soft handover, the first parameter configuration information further includes soft handover parameter configuration information.

In an implementation of this application, the method further includes the following step:
the third device receives a switching command from the second device, where the switching command is used for notifying the third device to perform sensing; the switching command includes second parameter configuration information; and the second parameter configuration information includes at least one of parameter information of the second signal, resource information of the second signal and soft handover parameter configuration information.

In an implementation of this application, the method further includes the following steps:
the third device performs configuration of a sensing parameter according to at least one of the first parameter configuration, the first request information and the second parameter configuration information; and the third device performs sensing according to the sensing parameter.

In an implementation of this application, the method further includes the following step:
the third device sends a switching success message to the second device after obtaining a measurement result and/or sensing result of at least one sensing measurement quantity.

In an implementation of this application, the method further includes the following step:
the third device receives second information from the second device, where the second information includes at least one of:
part or all of historical sensing measurement quantities;
part or all of historical sensing results; and
sensing target or sensing area prior information.

In an implementation of this application, the method further includes the following step:
the third device acquires second measurement configuration information,
where the second measurement configuration information includes at least one of:
a measurement object, including configuration information of the second signal;
measurement report configuration information, including at least one of a reporting method, a measurement content to be reported by the terminal, the type of a reference signal for measurement and the format of a measurement report; and
a measurement identity, where a measurement identity is used for associating at least one measurement object with at least one measurement report configuration.

In an implementation of this application, the measurement content includes at least one of a communication index, a sensing performance evaluation index, a sensing measurement quantity and a sensing result; and the reporting method includes periodic reporting or measurement event triggered reporting; and
in a case that the reporting method includes the measurement event triggered reporting, the second measurement configuration information further includes a second measurement event.

In an implementation of this application, the second measurement event includes at least one of the following:
a sensing performance evaluation index of the second signal measured by a candidate target cell satisfies a fifth preset condition;
a sensing measurement quantity for the second signal measured by a candidate target cell satisfies a sixth preset condition;
a sensing result of the second signal measured by a candidate target cell satisfies a seventh preset condition within a preset time period;
parameter information of the second signal estimated by at least one candidate target cell satisfies a sensing QoS minimum configuration requirement;
a state of a sensing target changes;
a position of the terminal changes; and
a communication related index of one or more second signals received by a serving cell and/or candidate target cell satisfies an eighth preset condition.

In an embodiment of this application, in a case of switching of a base station participating in a sensing process, the third device may measure a second signal; and the third device sends a second measurement report, and the second measurement report is used for determining whether to initiate switching, thus maintaining the continuity of sensing service and ensuring the user experience of sensing services based on the above process.

The embodiment of this application is applicable to scenarios where a serving cell performing sensing is switched to a target cell performing sensing.

The scenarios include the following two scenarios:

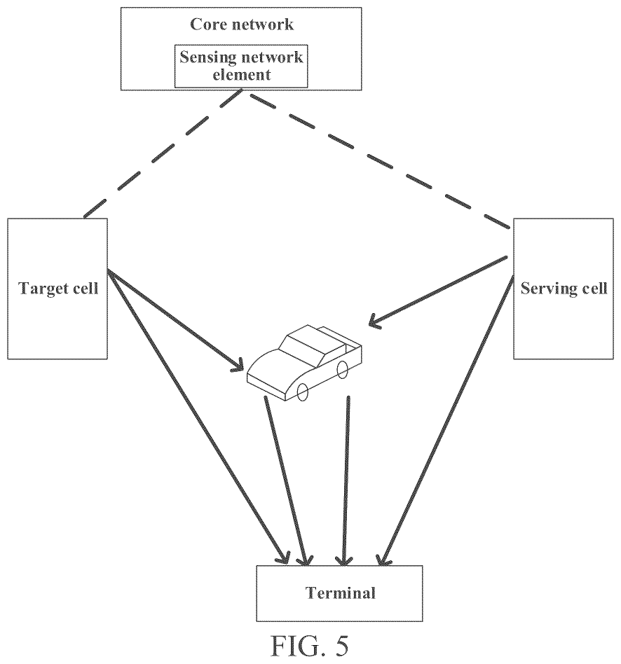

Scenario 1: switching from a serving cell performing downlink sensing to a target cell performing downlink sensing; as shown in FIG. 5, in an implementation, a terminal measures a first signal, the terminal may send a first measurement report to a serving cell, then the serving cell sends a measurement report to a sensing network element, and the sensing network element determines whether to initiate switching; in a case that the sensing network element determines to initiate switching, the sensing network element may send first request information to candidate target cells; and in a case that the candidate target cells determine to accept switching or perform sensing, the candidate target cells may send first response information to the sensing network element, the sensing network element determines at least one target cell from the candidate target cells as a cell performing sensing after switching based on the first response information, and sends a switching command to the target cell, and the target cell performs sensing parameter configuration and performs sensing.

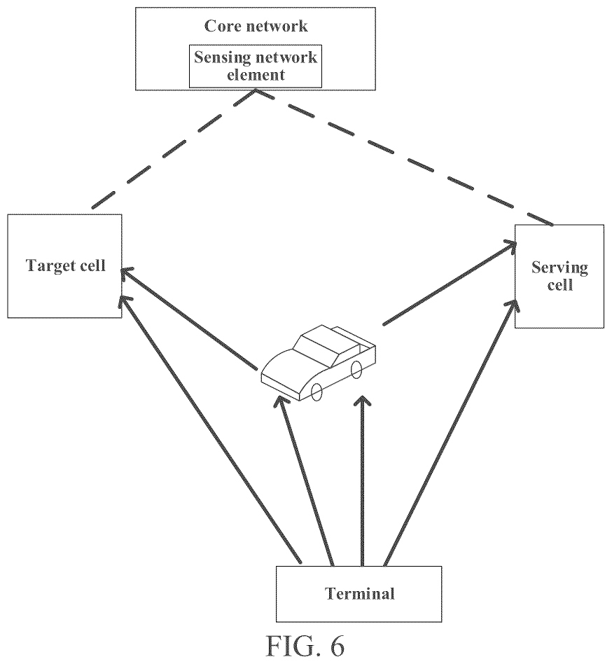

Scenario 2: switching from a serving cell performing uplink sensing to a target cell performing uplink sensing; as shown in FIG. 6, in an implementation, candidate target cells measure a second signal and may send a second measurement report to the serving cell, and the serving cell determines whether to initiate switching; in a case that the serving cell determines to initiate switching, the serving cell may send first request information to the candidate target cells; and in a case that the candidate target cells determine to accept switching or perform sensing, the candidate target cells may send first response information to the serving cell, the serving cell determines at least one target cell from the candidate target cells as a cell performing sensing after switching according to the first response information, and sends a switching command to the target cell, and the target cell performs sensing parameter configuration and performs sensing.

It is to be understood that the target cell and the serving cell may directly communicate with the terminal, or may communicate with the terminal through other devices (such as vehicle terminals).

In the above scenarios 1 and 2, it is assumed that the sensing node and the terminal have been already performing sensing at an early stage. The node performing sensing before switching is called the serving cell, and the cell performing sensing after switching is called the target cell. The terminal is the terminal performing sensing.

It is to be understood that the target cell and the serving cell may directly communicate with the terminal, or may communicate with the terminal through other devices (such as vehicle terminals).

The implementation of this application will be described in conjunction with embodiments 1, 2, 3 and 4, where the serving cell may also be referred to as the source base station, and the target cell may also be referred to as the target base station.

### Embodiment 1: Switching from a Serving Cell Performing Downlink Sensing to a Target Cell Performing Downlink Sensing

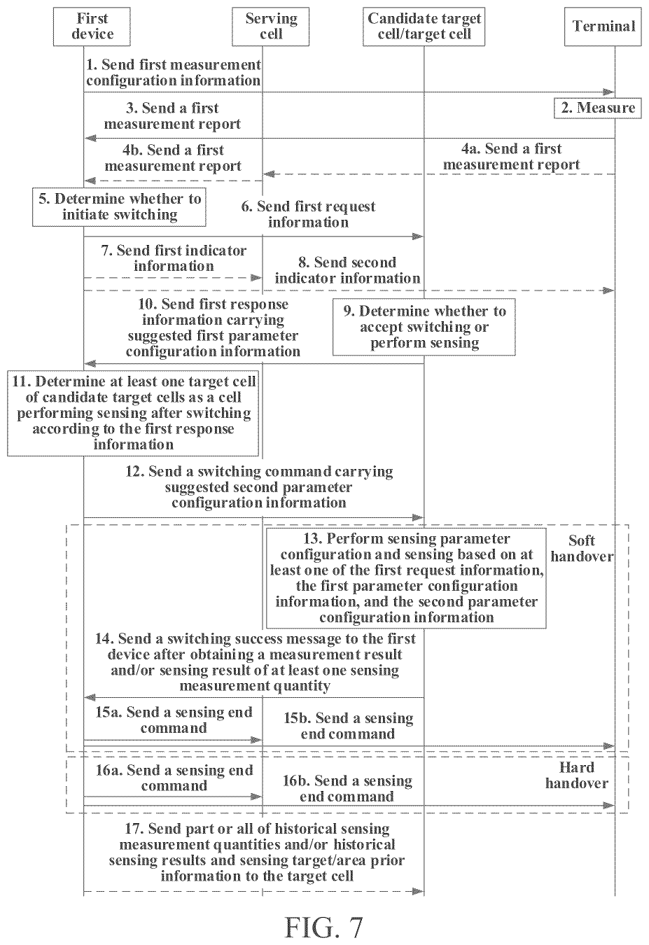

Referring to FIG. 7, steps include step 1 to step 17.

In step 1, a first device sends first measurement configuration information to a terminal.

The first measurement configuration information includes at least one of:
(1) a measurement object;
in some embodiments, the measurement object includes configuration information of the first signal;
(2) measurement report configuration information;
(3) a measurement ID;
(4) a first measurement event;
in some embodiments, the first measurement configuration information may also include (5) and/or (6):
(5) identity information of a sensing signal corresponding to a measurement quantity,
such as at least one of first signal information corresponding to a sensing measurement quantity, time information and frequency information of a sensing measurement quantity, information of a base station or Transmission and Reception Point (TRP) sending a first signal, information of an antenna port sending a first signal and the like; and
(6) a measurement cycle.

In some embodiments, the first measurement event includes at least one of the following:
(4.1) the sensing performance evaluation index of at least one candidate target cell and/or the serving cell satisfies a first preset condition;
(4.2) the sensing measurement quantity for at least one candidate target cell and/or the serving cell satisfies a second preset condition;
(4.3) the sensing result of at least one candidate target cell and/or the serving cell satisfies a third preset condition within a preset time period;
(4.4) parameter information of the first signal (such as parameter information of the sensing signal) sent by at least one candidate target cell satisfies a sensing QoS minimum configuration requirement;
in some embodiments, the parameter information of the sensing signal includes at least one of the following:
a) a waveform, such as Orthogonal Frequency Division Multiplexing (OFDM), Single Carrier Frequency Division Multiple Access (SC-FDMA), Orthogonal Time Frequency Space (OTFS), Frequency-Modulated Continuous-Wave (FMCW) and pulse signal;
b) a subcarrier interval, such as a subcarrier interval 30 KHz in an OFDM system;
c) a guard interval;
a time interval between the time that the sending of a signal ends and the time that the latest echo signal of the signal is received; this parameter is proportional to the maximum sensing distance; for example, the parameter may be calculated through 2dmax/c, where “dmax” is the maximum sensing distance (belonging to the sensing demand); for example, for spontaneously received sensing signals, “dmax” represents the maximum distance from a sensing signal transmitting and receiving point to a signal transmission point; in some cases, the Cyclic Prefix (CP) of OFDM signals can serve as the minimum guard interval; and “c” is the speed of light;
d) a bandwidth;
this parameter is inversely proportional to the distance resolution and may be obtained through c/2/delta_d, where “delta_d” is the distance resolution (belonging to the sensing demand);
c) a burst duration;
this parameter is inversely proportional to the rate resolution (belonging to the sensing demand), and this parameter is the time span of the sensing signal, and mainly used for calculating the Doppler frequency offset; and this parameter may be obtained by calculating through c/2/delta_v/fc, where “delta_v” is the speed resolution; and fc is the carrier frequency of the signal or the center frequency of the signal;
f) a time domain interval, to be obtained by calculating through c/2/fc/v_range, where “v_range” is equal to the maximum rate minus the minimum speed (belonging to the sensing demand); and this parameter is the time interval between two adjacent sensing signals;
g) power information of the transmitted signal, including a transmitting power, a peak power, an average power, a total power, a power spectral density, an Equivalent Isotropically Radiated Power (EIRP) and a power per port; and for example, a value is taken every 2 dBm from −20 dBm to 23 dBm for the transmitting power;
h) a signal format, such as a Sounding Reference Signal (SRS), a DeModulation Reference Signal (DMRS), a Positioning Reference Signal (PRS) or other predefined signals, and a related sequence format (associated with a sequence content or a sequence length and the like) and other information;
i) a signal direction, such as the direction of a sensing signal or beam information;
j) beam information or a Quasi Co-Located (QCL) relationship, for example, the sensing signal includes multiple resources, and each resource is QCL with a Synchronization Signal and PBCH Block (SSB), and QCL includes Type A, B, C, or D; and
k) an antenna configuration parameter (applicable to the transmission and reception of sensing signals by multi-antenna devices), including at least one of orthogonal methods of transmitting antennas (such as Time-Division Multiplexing (TDM), Code Division Multiplexing (CDM), Frequency-Division Multiplexing (FDM), or Direction Division Multiplexing (DDM)), the number of antenna ports, the number of antenna units, a distance between antenna units, the number of receiving channels, the number of transmitting channels, the number of transmitting antennas, and the (maximum) number of uplink or downlink Multiple Input Multiple Output (MIMO) layers.
(4.5) a state of a sensing target changes;
(4.6) a position of UE participating in sensing changes; and
(4.7) a switching event occurs.

For the introduction of the switching event, a reference may be made to Table 2.

TABLE 2
Switching event configuration.

| Event | Definition | Entry and exit conditions |
|---|---|---|
| Event A1 | The quality of the serving | Entry condition: Ms − Hys > Thresh |
| | cell is higher than the | Exit condition: Ms + Hys < Thresh |
| | threshold | |
| Event A2 | The quality of the serving | Entry condition: Ms + Hys < Thresh |
| | cell is lower than the | Exit condition: Ms − Hys > Thresh |
| | threshold | |
| Event A3 | The quality of the | Entry condition: |
| | neighboring cell is one | Mn + Ofn + Ocn − Hys > Mp + |
| | | Ofp + Ocp + Off |
| | | Exit condition: |
| | offset higher than that of | Mn + Ofn + Ocn + Hys < Mp + |
| | the serving cell | Ofp + Ocp + Off |
| Event A4 | The quality of the | Entry condition: Mn + Ofn + Ocn − Hys > |
| | neighboring cell is higher | Thresh |
| | than the threshold | Exit condition: Mn + Ofn + Ocn + Hys < |
| | | Thresh |
| Event A5 | The quality of the serving | Entry condition: Mp + Hys < Thresh1 |
| | cell is lower than | Mn + Ofn + Ocn − Hys > Thresh2 |
| | Threshold 1; and | Exit condition: Mp − Hys > Thresh 1 |
| | the quality of the | Mn + Ofn + Ocn + Hys < Thresh2 |
| | neighboring cell is higher | |
| | than Threshold 2 | |
| Event A6 | The quality of the | Entry condition: Mn + Ocn − Hys > Ms + |
| | neighboring cell is higher | Ocs + Off |
| | than that of the | Exit condition: Mn + Ocn + Hys < Ms + Ocs |
| | Secondary Cell (SCell) | + Off |
| Event B1 | The quality of the | Entry condition: Mn + Ofn + Ocn − Hys > |
| | Inter-RAT neighboring | Thresh |
| | cell is higher than the | Exit condition: Mn + Ofn + Ocn + Hys < |
| | threshold | Thresh |
| Event B2 | The quality of the | Entry condition: Mp + Hys < Thresh1 |
| | Primary Cell (PCell) is | Mn + Ofn + Ocn − Hys > Thresh2 |
| | lower than Threshold 1; | Exit condition: Mp − Hys > Thresh1 |
| | and | Mn + Ofn + Ocn + Hys < Thresh2 |
| | the quality of the | |
| | Inter-RAT neighboring | |
| | cell is higher than | |
| | Threshold 2 | |
| Event I1 | The interference quality | Entry condition: Mi − Hys > Thresh |
| | is higher than the | Exit condition: Mi + Hys < Thresh |
| | threshold | |

Taking Event A3 as an example, the meanings of the parameters for the entry and exit conditions are as follows:
Mn: a measurement result of a neighboring cell, without considering any offset;
Ofn: an offset for a measurement object of a neighboring cell;
Ocn: a cell-level offset for a neighboring cell;
Mp: a measurement result of a Special Cell (SpCell), without considering any offset;
SpCell may be a primary serving cell;
Ofp: an offset for a measurement object of an SpCell;
Ocp: a cell-level offset for an SpCell;
Hys: a hysteresis parameter of an event; and
Off: an offset parameter of an event.

To avoid ping-pong handover, for example, in CondTriggerConfig of a base station, a time to trigger (timeToTrigger) parameter is configured for each event. In a case that one or more candidate cells satisfy the entry condition of the event in Layer 3 (L3) filtering signal quality within timeToTrigger, the terminal selects the cells that satisfy the condition as trigger cells and select one from the trigger cells to perform condition reconfiguration.
(4.8) a communication related index of at least one candidate target cell and/or the serving cell satisfies a fourth preset condition.

In step 2, the terminal performs measurement (i.e., downlink sensing switching measurement).

In step 3, the terminal sends a first measurement report to a first device,
or step 4a and step 4b are performed, that is, the terminal sends a first measurement report to the serving cell, and the serving cell sends the first measurement report to the first device.

In step 5, the first device determines whether to initiate switching.

In some embodiments, the first device receives the first measurement report from the serving cell and the first device decides whether to initiate a switching request; or the first device decides whether to initiate a switching request according to the first measurement report received from the terminal.

In a case that the first device decides not to initiate switching, subsequent processing may include maintaining or ending current sensing.

In a case that the first device decides to initiate switching, and the first device decides to switch to a candidate target cell to perform sensing, step 6 is performed.

In some embodiments, the first device determines candidate target cells according to first information.

The first information includes at least one of the following:
1) position information of candidate target cells;
2) orientation information of antenna panels of candidate target cells;
3) sensing capability information of candidate target cells;
4) information of resources of candidate target cells available for sensing at present; and
5) channel state information of candidate target cells.

In step 6, the first device sends first request information to candidate target cells.

In some embodiments, the first request information includes at least one of:
1) a sensing demand;
2) a sensing QoS;
3) a sensing measurement quantity;
4) a sensing measurement result;
5) a sensing condition;
6) sensing target or sensing area prior information; and
7) a decision condition for deciding that sensing mode switching succeeds.

In some embodiments, in step 7, the first device sends first indicator information to the serving cell.

In some embodiments, in step 8, the first device sends second indicator information to the terminal.

In step 9, the candidate target cells determine whether to accept switching or perform sensing.

In step 10, the candidate target cells send first response information to the first device carrying suggested first parameter configuration information.

In a case that the candidate target cells agree to accept switching or perform sensing, the candidate target cells send first response information to the sending party (the first device) of the first request information. The first response information is used for indicating to the device which sends the first request information that the device which sends the first response information agrees to perform sensing.

In some embodiments, the candidate target cell feeds back the suggested first parameter configuration information in the first response information. The first parameter configuration information is used for configuring sensing parameters for the candidate target cells to perform sensing.

In some embodiments, the first parameter configuration information includes at least one of parameter information of the sensing signal and resource information of the sensing signal.

In a case that the first request information includes a soft handover request and the candidate target cells agree and supports soft handover, in some embodiments, first parameter configuration information further includes soft handover parameter configuration information. The soft handover request is used for requesting to perform a soft handover process.

In a case that the candidate target cells do not agree to accept switching or perform sensing, the candidate target cells send first refusal information to the sending party (the first device) of the first request information. The first refusal information is used for notifying the device which sends the first request information that the device which sends the first refusal information does not perform sensing.

In some embodiments, subsequent processing may be at least one of the following: i. the first device determines candidate target cells again; ii. current sensing is maintained; and iii. current sensing is ended.

In some embodiments, the candidate target cells decide whether to accept switching/perform sensing according to a device capability thereof. The device capacity includes at least one of a sensing related device capability, a sensing coverage range, a maximum bandwidth available for sensing, a maximum sustainable time for sensing services, supported types and frame formats of sensing signals, antenna array information, such as an array type, the number of antennas, an array aperture, antenna polarization characteristics, an element gain and directional characteristics, and supported sensing modes.

In step 11, the first device determines one target cell of the candidate target cells as a cell performing sensing after switching according to the first response information.

In step 12, the first device sends a switching command to the target cell carrying suggested second parameter configuration information.

The second parameter configuration information is used for configuring sensing parameters for the target cell to perform sensing. For the content in the second parameter configuration information, a reference may be made to the content in the first parameter configuration information.

In some embodiments, second parameter configuration information includes soft handover parameter configuration information.

Following steps 13, 14, 15a, and 15b belong to the soft handover process, while steps 16a and 16b belong to the hard handover process, that is, after step 12, either soft handover or hard handover may be performed.

In step 13, the target cell performs sensing parameter configuration and downlink sensing based on at least one of the first request information, the first parameter configuration information, and the second parameter configuration information.

In step 14, the target cell sends a switching success message to the first device after obtaining a measurement result and/or sensing result of at least one sensing measurement quantity.

In step 15a and step 15b, the first device sends a sensing end command (i.e., third indicator information) to the serving cell and the terminal.

In a case that soft handover is adopted, the target cell performs sensing parameter configuration and downlink sensing based on at least one of the first request information, the first parameter configuration information, and the second parameter configuration information. The target cell sends a switching success message to the first device after obtaining a measurement result and/or sensing result of at least one sensing measurement quantity.

Further, the device which sends the first request information is the first device, and the first device sends a sensing end command (i.e., third indicator information) to the serving cell and the UE after receiving the switching success message.

After the serving cell and the UE receive the sensing end command, the serving cell and the UE end the original sensing operation and release the resources occupied by sensing, such as a time resource and a frequency resource and an antenna port resource.

In step 16a and step 16b, the first device sends a sensing end command (i.e., third indicator information) to the serving cell and the terminal.

In a case that hard handover is adopted, step 12 is performed, and the first device does not need to wait for the switching success message. The first device directly sends a sensing end command to the serving cell and the terminal. After the serving cell and the UE receive the sensing end command, the serving cell and the terminal end the original sensing operation and release the resources occupied by sensing, such as a time resource and a frequency resource and an antenna port resource.

In step 17, the first device sends part or all of historical sensing measurement quantities and/or historical sensing results and sensing target or area prior information to the target cell.

### Embodiment 2: Switching from a Serving Cell Performing Downlink Sensing to a Target Cell Performing Downlink Sensing

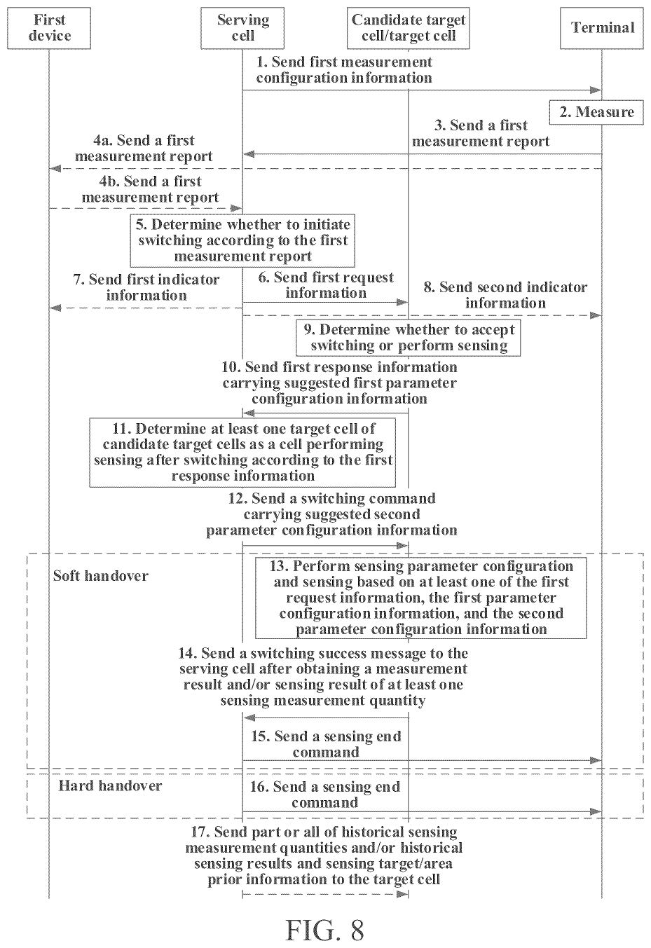

Referring to FIG. 8, steps include the following steps:

In step 1, a serving cell sends first measurement configuration information to a terminal.

In step 2, the terminal performs measurement (i.e., downlink sensing switching measurement).

In step 3, the terminal sends a first measurement report to the serving cell, or step 4a and step 4b are performed, that is, the terminal sends a first measurement report to a first device, and the first device sends the first measurement report to the serving cell.

In step 5, the serving cell determines whether to initiate switching.

In a case that the serving cell determines not to initiate switching, subsequent processing may include maintaining or ending current sensing. In a case that the serving cell determines to initiate switching, step 6 is continuously performed.

In step 6, the serving cell sends first request information to candidate target cells.

In some embodiments, in step 7, the serving cell sends first indicator information to the first device.

In some embodiments, the first request information may include a soft handover request.

In some embodiments, in step 8, the serving cell sends second indicator information to the terminal, where the second indicator information is used for indicating to the terminal that the serving cell no longer participates in sensing after switching is completed.

In step 9, the candidate target cells determine whether to accept switching or perform sensing.

In a case that the candidate target cells do not agree to accept switching or perform sensing, the candidate target cells send first refusal information to the sending party (the serving cell) of the first request information. The first refusal information is used for notifying the device which sends the first request information that the device which sends the first refusal information does not perform sensing.

Subsequent processing may be at least one of the following: i. the serving cell determines candidate target cells again; ii. current sensing is maintained; and iii. current sensing is ended.

In step 10, the candidate target cells send first response information to the serving cell carrying suggested first parameter configuration information.

In step 11, the serving cell determines one target cell of the candidate target cells as a cell performing sensing after switching according to the first response information.

In step 12, the serving cell sends a switching command to the target cell carrying suggested second parameter configuration information.

Following steps 13, 14 and 15 belong to the soft handover process, while step 16 belongs to the hard handover process, that is, after step 12, either soft handover or hard handover may be performed.

In step 13, the target cell performs sensing parameter configuration and sensing based on at least one of the first request information, the first parameter configuration information, and the second parameter configuration information.

In step 14, the target cell sends a switching success message to the serving cell after obtaining a measurement result and/or sensing result of at least one sensing measurement quantity.

In step 15, the serving cell sends a sensing end command (i.e., third indicator information) to the terminal.

In a case that soft handover is adopted, the target cell performs sensing parameter configuration and downlink sensing based on at least one of the first request information, the first parameter configuration information, and the second parameter configuration information.

The target cell sends a switching success message to the serving cell after obtaining a measurement result and/or sensing result of at least one sensing measurement quantity.

Further, the device which sends the first request information is the serving cell, and the serving cell sends a sensing end command to the UE after receiving the switching success message. The UE ends the original sensing operation and releases the resources occupied by sensing. For example, the resources include at least one of a time resource and a frequency resource, an antenna port resource and the like.

In step 16, the serving cell sends a sensing end command (i.e., third indicator information) to the terminal.

In a case that the hard handover process is adopted, step 12 is performed, and the serving cell does not need to wait for the switching success message.

The serving cell sends a sensing end command to the terminal. The terminal ends the original sensing operation and releases the resources occupied by sensing. For example, the resources may include at least one of a time resource and a frequency resource, an antenna port resource and the like.

In step 17, the serving cell sends part or all of historical sensing measurement quantities and/or historical sensing results and sensing target or area prior information to the target cell.

### Embodiment 3: Switching from a Serving Cell Performing Uplink Sensing to a Target Cell Performing Uplink Sensing

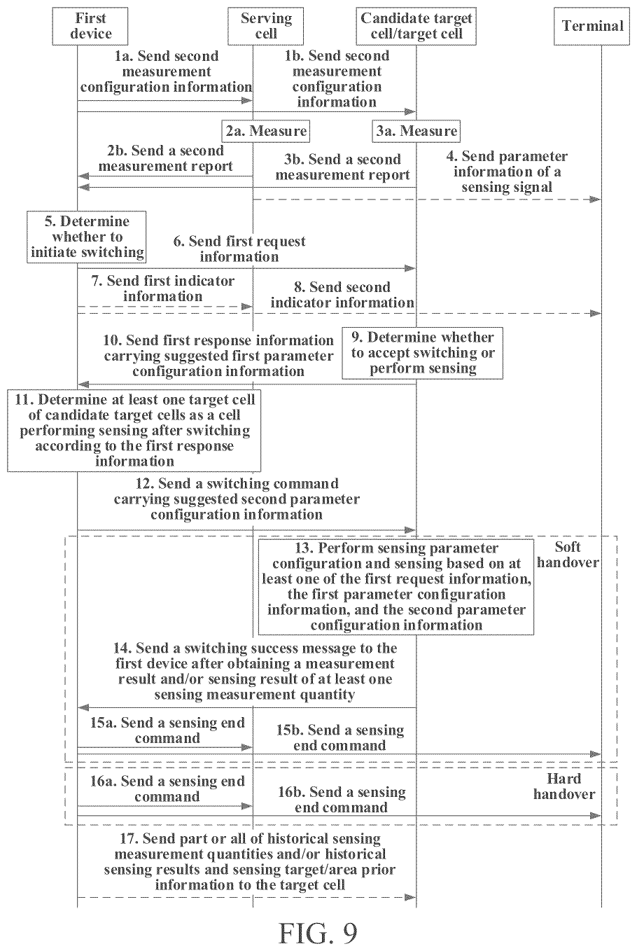

Referring to FIG. 9, steps are as follows:

In step 1a, a first device sends second configuration information to a serving cell.

In step 1b, the first device sends second measurement configuration information to a target cell.

The second measurement configuration information includes at least one of:
(1) a measurement object,
such as parameter information and resource information of one or more second signals sent by the terminal that the base station needs to measure;
(2) measurement report configuration, including a principle of reporting, to be periodic reporting or measurement event triggered reporting; a type of reference signal for measurement and the like; a format of measurement report, such as the maximum number of reported cells and the number of beams;
(3) a measurement ID, used for associating a measurement object with measurement report configuration information;
(4) a second measurement event;
in some embodiments, the second measurement configuration information may further include (5) and/or (6);
(5) identity information of a second signal corresponding to a measurement quantity,
such as second signal information corresponding to a sensing measurement quantity, time information and frequency information of a sensing measurement quantity, information of a base station or TRP sending a second signal and information of an antenna port sending a second signal; and
(6) a measurement cycle.

In some embodiments, the second measurement event includes at least one of the following:
4.1) A sensing performance evaluation index of the second signal satisfies a fifth preset condition.

For example, the sensing performance evaluation index of the second signal measured by the candidate target cell remains at or above a preset threshold within a preset time period, or exceeds the preset threshold for a preset number of times within the preset time period. For another example, the sensing performance evaluation index of the second signal measured by the candidate target cell is superior to the sensing performance evaluation index of the second signal measured by the serving cell within a preset time period, or exceeds the sensing performance evaluation index of the second signal measured by the serving cell for a preset number of times within the preset time period.
4.2) A sensing measurement quantity for the second signal satisfies a sixth preset condition.

For example, the sensing measurement quantity for the second signal measured by the candidate target cell the remains at or above a preset threshold within a preset time period, or exceeds the preset threshold for a preset number of times within the preset time period. For another example, the sensing measurement quantity for the second signal measured by the candidate target cell is superior to the sensing measurement quantity for the second signal measured by the serving cell within a preset time period, or exceeds the sensing measurement quantity for the second signal measured by the serving cell for a preset number of times within the preset time period.
4.3) A sensing result of the second signal satisfies a seventh preset condition within a preset time period.

For example, the sensing result of the second signal measured by the candidate target cell is superior to the sensing result of the serving cell within a preset time period.
4.4) Parameter information of the second signal satisfies a sensing QoS minimum configuration requirement.
4.5) A state of a sensing target changes.

In some embodiments, the state includes at least one of position and speed.
4.6) A position of UE participating in sensing changes.
4.7) A switching event occurs.
4.8) A communication related index of one or more second signals received by a serving cell and/or neighboring cell satisfies an eighth preset condition. The communication related index includes at least one of an RSRP, an SINR, an RSRQ, an RSSI and the like. For example, the communication related index of the candidate target cell is superior to the communication related index of the serving cell within a preset time period.

It is to be understood that to determine whether the second measurement event is satisfied, the average value of multiple measurement quantities/indexes at different times (layer 1 filtering and/or layer 3 filtering) may be used to avoid the randomness/ping-pong effect caused by determination according to a single result.

Multiple second signals may correspond to multiple transmitting/receiving beam pairs, and whether a second measurement event is satisfied may be determined according to the measurement quantity/index of one or more beams.

The second measurement report at least includes the measurement result of the sensing measurement quantity required for switching measurement. The sensing measurement quantity required for switching measurement may include a sensing measurement quantity for a current sensing service.

In step 2a and step 2b, the serving cell performs measurement (i.e., uplink sensing switching measurement), and sends a switching measurement report to the first device.

In step 3a and step 3b, the target cell performs measurement (i.e., uplink sensing switching measurement), and sends a switching measurement report to the first device.

It is to be understood that steps 1a, 2a and 2b, and steps 1b, 3a and 3b may be performed alternatively, sequentially or simultaneously.

In some embodiments, in step 4, the serving cell sends parameter information of a sensing signal to the terminal, and the terminal sends the sensing signal according to the parameter of the sensing signal, so that the serving cell and candidate target cells measure the sensing signal.

In some embodiments, the terminal sends a switching measurement report to the serving cell, and the serving cell sends the switching measurement report to the first device.

In step 5, the first device determines whether to initiate switching.

In step 6, the first device sends first request information to candidate target cells.

In step 6, the first device determines at least one candidate target cell performing sensing according to first information, and then the first device sends first request information to at least one candidate target cell.

In some embodiments, in step 7, the first device sends first indicator information to the serving cell.

In some embodiments, in step 8, the first device sends second indicator information to the terminal.

In step 9, the candidate target cells determine whether to accept switching or perform sensing.

In step 10, the candidate target cells send first response information to the first device carrying suggested first parameter configuration information.

In step 11, the first device determines one target cell of the candidate target cells as a cell performing sensing after switching according to the first response information.

In step 12, the first device sends a switching command to the target cell carrying suggested second parameter configuration information.

Following steps 13, 14, 15a, and 15b belong to the soft handover process, while steps 16a and 16b belong to the hard handover process, that is, after step 12, either soft handover or hard handover may be performed.

In step 13, the target cell performs sensing parameter configuration and sensing based on at least one of the first request information, the first parameter configuration information, and the second parameter configuration information.

In step 14, the target cell sends a switching success message to the first device after obtaining a measurement result and/or sensing result of at least one sensing measurement quantity.

In step 15a, the first device sends a sensing end command to the serving cell.

In step 15b, the first device sends a sensing end command (i.e., third indicator information) to the terminal.

In step 16a, the first device sends a sensing end command to the serving cell.

In step 16b, the first device sends a sensing end command (i.e., third indicator information) to the terminal.

In step 17, the first device sends part or all of historical sensing measurement quantities and/or historical sensing results and sensing target or area prior information to the target cell.

### Embodiment 4: Switching from a Serving Cell Performing Uplink Sensing to a Target Cell Performing Uplink Sensing

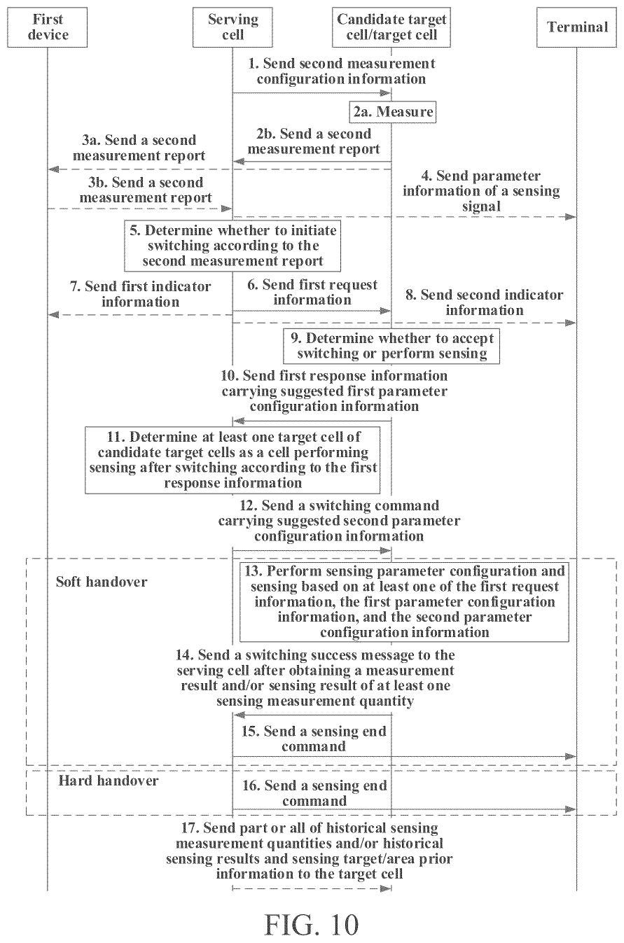

Referring to FIG. 10, steps include the following steps:

In step 1, a serving cell sends second measurement configuration information to candidate target cells.

In step 2a and step 2b, the candidate target cells perform measurement (i.e., uplink sensing switching measurement), and send a second measurement report.

In some embodiments, in step 3a and step 3b, the candidate target cells send a second measurement report to a first device, and the first device sends the second measurement report to the serving cell.

In some embodiments, in step 4, the serving cell sends parameter information of a second signal to a terminal, and the terminal sends the second signal according to the parameter of the second signal, so that the serving cell and the candidate target cells measure the second signal.

In step 5, the serving cell determines whether to initiate switching.

In step 6, the serving cell sends first request information to candidate target cells.

In some embodiments, in step 7, the serving cell sends first indicator information to the first device.

In some embodiments, in step 8, the serving cell sends a second indicator information to the terminal.

In step 9, the candidate target cells determine whether to accept switching or perform sensing.

In step 10, the candidate target cells send first response information to the serving cell carrying suggested first parameter configuration information.

In step 11, the serving cell determines one target cell of the candidate target cells as a cell performing sensing after switching according to the first response information.

In step 12, the serving cell sends a switching command to the target cell carrying suggested second parameter configuration information.

Following steps 13, 14 and 15 belong to the soft handover process, while step 16 belongs to the hard handover process, that is, after step 12, either soft handover or hard handover may be performed.

In step 13, the target cell performs sensing parameter configuration and sensing based on at least one of the first request information, the first parameter configuration information, and the second parameter configuration information.

In step 14, the target cell sends a switching success message to the serving cell after obtaining a measurement result and/or sensing result of at least one sensing measurement quantity.

In step 15, the serving cell sends a sensing end command (i.e., third indicator information) to the terminal.

In step 16, the serving cell sends a sensing end command to the terminal.

In step 17, the serving cell sends part or all of historical sensing measurement quantities and/or historical sensing results and sensing target or area prior information to the target cell.

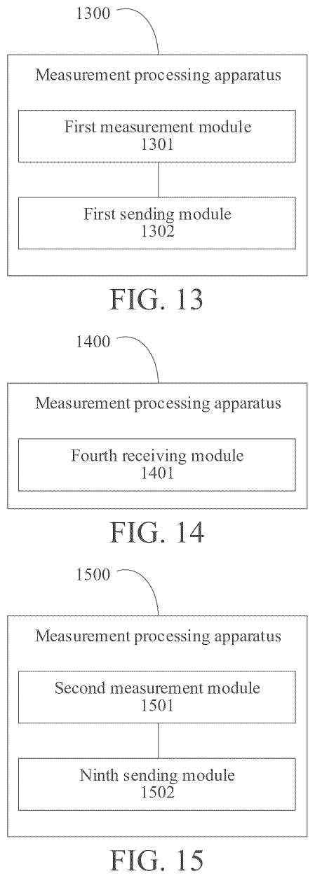

Referring to FIG. 13, an embodiment of this application provides a measurement processing apparatus applied to a terminal. The apparatus 1300 includes:
a first measurement module 1301 configured to measure a first signal; and
a first sending module 1302 configured to send a first measurement report to a first device or a serving cell of the terminal,
where a measurement quantity for measuring the first signal includes at least one of:
a sensing measurement quantity;
a sensing performance evaluation index; and a sensing measurement result.

In an implementation of this application, the first signal includes at least one of a sensing signal, a reference signal, a synchronization signal and a data signal sent by the serving cell of the terminal or candidate target cells.

In an implementation of this application, the first sending module 1302 is further configured to send a first measurement report to a first device or a serving cell of the terminal,
where the first device includes at least one of a sensing network function, a sensing network element and a sensing management function.

In an implementation of this application, a measurement quantity for measuring the first signal further includes at least one of:
an RSRP;
an RSRQ;
an SINR; and
an RSSI.

In an implementation of this application, the apparatus further includes:
a first receiving module configured to receive first measurement configuration information,
where the first measurement configuration information includes at least one of: a measurement object, including configuration information of the first signal;
measurement report configuration information, including at least one of a reporting method, a measurement content to be reported by the terminal, the type of a reference signal for measurement and the format of a measurement report; and
a measurement identity, where a measurement identity is used for associating at least one measurement object with at least one measurement report configuration.

In an implementation of this application, the measurement content includes at least one of a communication index, a sensing performance evaluation index, a sensing measurement quantity and a sensing result; and the reporting method includes periodic reporting or measurement event triggered reporting; and
in a case that the reporting method includes the measurement event triggered reporting, the first measurement configuration information further includes a first measurement event.

In an implementation of this application, the first measurement event includes at least one of the following:
the sensing performance evaluation index of at least one candidate target cell and/or the serving cell satisfies a first preset condition;
the sensing measurement quantity for at least one candidate target cell and/or the serving cell satisfies a second preset condition;
the sensing result of at least one candidate target cell and/or the serving cell satisfies a third preset condition within a preset time period;
parameter information of the first signal sent by at least one candidate target cell satisfies a sensing QoS minimum configuration requirement;
a state of a sensing target changes;
a position of the terminal changes; and
a communication related index of at least one candidate target cell and/or the serving cell satisfies a fourth preset condition.

In an implementation of this application, the apparatus further includes:
a second receiving module configured to receive second indicator information, where the second indicator information is used for indicating that the serving cell no longer participates in sensing after switching is completed; or
receive third indicator information, where the third indicator information is used for indicating that sensing related to the serving cell ends.

In an implementation of this application, the apparatus further includes:
a third receiving module configured to receive configuration information sent by the serving cell, where the configuration information includes at least one of a cell identity of a target cell and random access channel information; and
random access information used for initiating random access to the target cell.

The apparatus provided in the embodiment of this application can implement the various processes implemented in the method embodiment in FIG. 2 and achieve the same technical effect, and the description will not be repeated here in order to avoid repetition.

Referring to FIG. 14, an embodiment of this application provides a measurement processing apparatus applied to a second device. The apparatus 1400 includes:
a fourth receiving module 1401 configured to receive a first measurement report or a second measurement report, where the first measurement report is obtained by a terminal measuring a first signal, and the second measurement report is obtained by a third device measuring a second signal,
where a measurement quantity for the terminal to measure the first signal or a measurement quantity for the third device to measure the second signal includes at least one of: a sensing measurement quantity; a sensing performance evaluation index; and a sensing measurement result.

In an implementation of this application, the first signal includes at least one of a sensing signal, a reference signal, a synchronization signal and a data signal sent by the serving cell of the terminal or candidate target cells;
or the second signal includes at least one of a sensing signal, a reference signal, a synchronization signal and a data signal sent by the terminal.

In an implementation of this application, the measurement quantity for the terminal to measure the first signal or the measurement quantity for the third device to measure the second signal further includes at least one of:
an RSRP;
an RSRQ;
an SINR; and
an RSSI.

In an implementation of this application, the second device includes a first device, and the first device includes at least one of a sensing network function, a sensing network element and a sensing management function, or the second device is associated with the serving cell of the terminal.

In an implementation of this application, the apparatus further includes:
a first processing module configured to determine whether to initiate switching according to the first measurement report or the second measurement report; and a second processing module configured to determine at least one candidate target cell performing sensing in a case that it is determined to initiate switching.

In an implementation of this application, the second processing module is further configured to determine at least one candidate target cell performing sensing according to first information,
where the first information includes at least one of:
position information of candidate target cells;
orientation information of antenna panels of candidate target cells;
sensing capability information of candidate target cells;
information of resources of candidate target cells available for sensing at present; and
channel state information of candidate target cells.

In an implementation of this application, the apparatus further includes:
a second sending module configured to send first request information to at least one candidate target cell, where the first request information is used for requesting at least one candidate target cell to perform sensing; and
where the first request information includes at least one of:
a soft handover request;
a sensing demand;
a sensing QoS;
a sensing measurement quantity;
a sensing measurement result;
a sensing condition;
sensing target or sensing area prior information; and
a decision condition for deciding that sensing mode switching succeeds.

In an implementation of this application, the apparatus further includes:
a third sending module configured to send first indicator information to the serving cell, where the second device is the first device; or send first indicator information to the first device, where the second device is associated with the serving cell of the terminal,
where the first indicator information is used for indicating that at least one candidate target cell performs sensing.

In an implementation of this application, the apparatus further includes:
a fourth sending module configured to send second indicator information to the terminal, where the second indicator information is used for indicating that the serving cell no longer participates in sensing after switching is completed.

In an implementation of this application, the apparatus further includes:
a fifth receiving module configured to receive first refusal information, where the first refusal information is used for indicating that a device which sends the first refusal information does not perform sensing.

In an implementation of this application, the apparatus further includes:
a sixth receiving module configured to receive first response information, where the first response information is used for indicating that a device which sends the first response information agrees to perform sensing.

In an implementation of this application, the apparatus further includes:
a third processing module configured to determine one target cell of the candidate target cells as a cell performing sensing after switching according to the first response information; and
a fifth sending module configured to send a switching command to the target cell, where the switching command includes second parameter configuration information, where the second parameter configuration information includes at least one of parameter information of the first signal or the second signal, resource information of the first signal or the second signal and soft handover parameter configuration information.

In an implementation of this application, the first response information includes first parameter configuration information, where the first parameter configuration information includes at least one of parameter information of the first signal or the second signal and resource information of the first signal or the second signal.

In an implementation of this application, in a case that the first request information includes a soft handover request and the candidate target cell agrees and supports soft handover, the first parameter configuration information further includes soft handover parameter configuration information.

In an implementation of this application, the apparatus further includes:
a sixth sending module configured to, after the second device receives a switching success message from the target cell, send third indicator information to the terminal; or send third indicator information to the terminal, where the third indicator information is used for indicating that sensing related to the serving cell ends.

In an implementation of this application, the apparatus further includes:
a seventh sending module configured to send second information to the target cell, where the second information includes at least one of:
part or all of historical sensing measurement quantities;
part or all of historical sensing results; and
sensing target or sensing area prior information.

In an implementation of this application, the apparatus further includes:
an eighth sending module configured to send first measurement configuration information or second measurement configuration information,
where the first measurement configuration information or the second measurement configuration information includes at least one of:
a measurement object, including configuration information of the first signal or the second signal;
measurement report configuration information, including at least one of a reporting method, the type of a reference signal for measurement and the format of a measurement report; and
a measurement identity, where a measurement identity is used for associating at least one measurement object with at least one measurement report configuration.

In an implementation of this application, the reporting method includes periodic reporting or measurement event triggered reporting; and
in a case that the reporting method includes the measurement event triggered reporting, the first measurement configuration information further includes a first measurement event or the second measurement configuration information further includes a second measurement event.

In an implementation of this application, the first measurement event includes at least one of the following:
the sensing performance evaluation index of at least one candidate target cell and/or the serving cell satisfies a first preset condition;
the sensing measurement quantity for at least one candidate target cell and/or the serving cell satisfies a second preset condition;
the sensing result of at least one candidate target cell and/or the serving cell satisfies a third preset condition within a preset time period;
parameter information of the first signal sent by at least one candidate target cell satisfies a sensing QoS minimum configuration requirement;
a state of a sensing target changes;
a position of the terminal changes; and
a communication related index of at least one candidate target cell and/or the serving cell satisfies a fourth preset condition.

In an implementation of this application, the second measurement event includes at least one of the following:
a sensing performance evaluation index of the second signal satisfies a fifth preset condition;
a sensing measurement quantity for the second signal satisfies a sixth preset condition;
a sensing result of the second signal satisfies a seventh preset condition within a preset time period;
parameter information of the second signal satisfies a sensing QoS minimum configuration requirement;
a state of a sensing target changes;
a position of the terminal changes; and
a communication related index of the second signal satisfies an eighth preset condition.

The apparatus provided in the embodiment of this application can implement the various processes implemented in the method embodiment illustrated in FIG. 3 and achieve the same technical effect, and the description will not be repeated here in order to avoid repetition.

Referring to FIG. 15, an embodiment of this application provides a measurement processing apparatus applied to a third device. The apparatus 1500 includes:
a second measurement module 1501 configured to measure a second signal; and
a ninth sending module 1502 configured to send a second measurement report,
where a measurement quantity for measuring the second signal includes at least one of: a sensing measurement quantity; a sensing performance evaluation index; and a sensing measurement result; and
the second signal includes at least one of a sensing signal, a reference signal, a synchronization signal and a data signal sent by the terminal.

In an implementation of this application, the apparatus further includes:
a seventh receiving module configured to receive first request information from a second device, where the first request information is used for requesting at least one candidate target cell to perform sensing; and
a fourth processing module configured to determine whether to accept switching or perform sensing,
where the second device includes a first device, and the first device includes at least one of a sensing network function, a sensing network element and a sensing management function, or the second device is associated with a serving cell of the terminal; and
the first request information includes at least one of:
a soft handover request;
a sensing demand;
a sensing QoS;
a sensing measurement quantity;
a sensing measurement result;
a sensing condition;
sensing target or sensing area prior information; and
a decision condition for deciding that sensing mode switching succeeds.

In an implementation of this application, the apparatus further includes:
a tenth sending module configured to send first response information to the second device in a case that the third device determines to accept switching or perform sensing, where the first response information is used for indicating that a device which sends the first response information agrees to perform sensing, where the first response information includes first parameter configuration information; and the first parameter configuration information includes at least one of parameter information of the second signal and resource information of the second signal.

In an implementation of this application, in a case that the first request information includes a soft handover request and the candidate target cell agrees and supports soft handover, the first parameter configuration information further includes soft handover parameter configuration information.

In an implementation of this application, the apparatus further includes:
an eighth receiving module configured to receive a switching command from the second device, where the switching command is used for notifying the third device to perform sensing; the switching command includes second parameter configuration information; and the second parameter configuration information includes at least one of parameter information of the second signal, resource information of the second signal and soft handover parameter configuration information.

In an implementation of this application, the apparatus further includes:
a fifth processing module configured to perform configuration of a sensing parameter according to at least one of the first parameter configuration, the first request information and the second parameter configuration information; and the third device performs sensing according to the sensing parameter.

In an implementation of this application, the apparatus further includes:
an eleventh sending module configured to send a switching success message to the second device after obtaining a measurement result and/or sensing result of at least one sensing measurement quantity.

In an implementation of this application, the apparatus further includes:
a ninth receiving module configured to receive second information from the second device, where the second information includes at least one of:
part or all of historical sensing measurement quantities;
part or all of historical sensing results; and
sensing target or sensing area prior information. In an implementation of this application, the apparatus further includes:
a tenth receiving module configured to obtain second measurement configuration information,
where the second measurement configuration information includes at least one of:
a measurement object, including configuration information of the second signal;
measurement report configuration information, including at least one of a reporting method, the type of a reference signal for measurement and the format of a measurement report; and
a measurement identity, where a measurement identity is used for associating at least one measurement object with at least one measurement report configuration.

In an implementation of this application, the reporting method includes periodic reporting or measurement event triggered reporting; and
in a case that the reporting method includes the measurement event triggered reporting, the second measurement configuration information further includes a second measurement event.

In an implementation of this application, the second measurement event includes at least one of the following:
a sensing performance evaluation index of the second signal satisfies a fifth preset condition;
a sensing measurement quantity for the second signal satisfies a sixth preset condition;
a sensing result of the second signal satisfies a seventh preset condition within a preset time period;
parameter information of the second signal satisfies a sensing QoS minimum configuration requirement;
a state of a sensing target changes;
a position of the terminal changes; and
a communication related index of the second signal satisfies an eighth preset condition.

The apparatus provided in the embodiment of this application can implement the various processes implemented in the method embodiment illustrated in FIG. 4 and achieve the same technical effect, and the description will not be repeated here in order to avoid repetition.

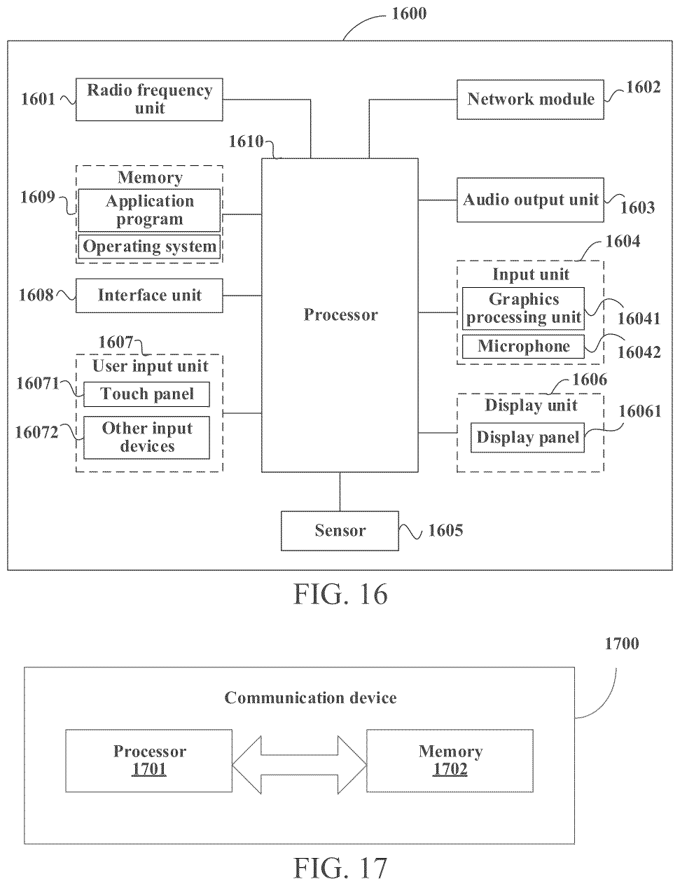

An embodiment of this application further provides a terminal. For example, FIG. 16 is a schematic diagram of a hardware structure of a terminal according to an embodiment of this application.

The terminal 1600 includes, but is not limited to, at least part of components such as a radio frequency unit 1601, a network module 1602, an audio output unit 1603, an input unit 1604, a sensor 1605, a display unit 1606, a user input unit 1607, an interface unit 1608, a memory 1609, and a processor 1610.

It can be understood by those skilled in the art that the terminal 1600 may further include a power supply (such as a battery) for supplying power to the components. The power supply may be logically connected to the processor 1610 by a power supply management system, thus implementing functions such as charging, discharging, and power consumption management by using the power supply management system. The terminal structure illustrated in FIG. 16 constitutes no limitation on the terminal, and the terminal may include more or fewer components than those illustrated therein, or some components may be combined, or a different component deployment may be used, and the description will not be repeated here.

It is to be understood that in the embodiments of this application, the input unit 1604 may include a Graphics Processing Unit (GPU) 16041 and a microphone 16042. The graphics processing unit 16041 performs processing on image data of a static picture or a video that is obtained by an image acquisition device (for example, a camera) in a video acquisition mode or an image acquisition mode. The display unit 1606 may include a display panel 16061. The display panel 16061 may be configured in the form of liquid crystal display, organic light emitting diode and the like. For example, the user input unit 1607 includes at least one of a touch panel 16071 and other input devices 16072. The touch panel 16071 is also known as touch screen. The touch panel 16071 may include two parts, namely a touch detection apparatus and a touch controller. The other input devices 16072 may include, but is not limited to, a physical keyboard, a functional key (such as a volume control key or an on/off key), a track ball, a mouse, and a joystick, and the description will not be repeated here.

In the embodiment of this application, the radio frequency unit 1601 receives downlink data from the network device and then transmits the downlink data to the processor 1610 for processing. In addition, the radio frequency unit 1601 may send uplink data to the network device. Generally, the radio frequency unit 1601 includes, but is not limited to, an antenna, an amplifier, a transceiver, a coupler, a low noise amplifier and a duplexer.

The memory 1609 may be configured to store a software program or instruction and various data. The memory 1609 may mainly include a first storage area and a second storage area for storing a program or instruction. The first storage area may store an operating system, an application program or instruction required by at least one function (for example, a sound playback function or an image display function) and the like. In addition, the memory 1609 may be a volatile memory or a non-volatile memory, or the memory 1609 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM) and a Direct Rambus RAM (DRRAM). The memory 1609 in the embodiment of this application includes, but is not limited to, these memories and any other suitable types of memories.

The processor 1610 may include one or more processing units. In some embodiments, the processor 1610 may integrate an application processor and a modem processor. The application processor mainly processes operations of an operating system, a user interface, an application program and the like. The modem processor mainly processes wireless communication signal, for example, a baseband processor. It is to be understood that the foregoing modem processor may not be integrated into the processor 1610.

The terminal provided in the embodiment of this application can implement the various processes implemented in the method embodiment in FIG. 2 and achieve the same technical effect, and the description will not be repeated here in order to avoid repetition.

For example, referring to FIG. 17, an embodiment of this application further provides a communication device 1700, including a processor 1701 and a memory 1702. A program or instruction runnable on the processor 1701 is stored on the memory 1702. For example, in a case that the communication device 1700 is a terminal, the program or instruction, when executed by the processor 1701, implements the various steps of the method embodiment in FIG. 2, and can achieve the same technical effect; in a case that the communication device 1700 is a network device, the program or instruction, when executed by the processor 1701, implements the various steps of the method embodiment in FIG. 3 or FIG. 4, and can achieve the same technical effect, and the description will not be repeated here in order to avoid repetition.

An embodiment of this application further provides a readable storage medium. A program or instruction is stored on the readable storage medium. The program or instruction, when executed by the processor, implements the various processes of the method in FIG. 2, FIG. 3 or FIG. 4 and the above embodiments, and can achieve the same technical effect, and the description will not be repeated here in order to avoid repetition.

The processor is a processor in the terminal in the above embodiments. The readable storage medium may include a computer-readable storage medium, such as a read-only memory ROM, a random access memory RAM, a magnetic disk, an optical disc and the like.

An embodiment of this application further provides a chip. The chip includes a processor and a communication interface coupled to the processor. The processor is configured to run a program or instruction to implement the various processes of the method embodiment in FIG. 2, FIG. 3 or FIG. 4, and can achieve the same technical effect, and the description will not be repeated here in order to avoid repetition.

It is to be understood that the chip provided in the embodiment of this application may also be referred to as system level chip, system chip, chip system, or system on chip.

An embodiment of this application further provides a computer program/program product. The computer program/program product is stored on a storage medium. The computer program/program product, when executed by at least one processor, implements the various processes of the method embodiment in FIG. 2, FIG. 3 or FIG. 4, and can achieve the same technical effect, and the description will not be repeated here in order to avoid repetition.

An embodiment of this application further provides a communication system. The communication system includes a terminal and a network device. The terminal is configured to perform the various processes in FIG. 2 and the above method embodiments. The network device is configured to perform the various processes in FIG. 3 or FIG. 4 and the above method embodiments, and can achieve the same technical effect, and the description will not be repeated here in order to avoid repetition.

It is to be understood that the terms “include”, “comprise”, or any other variation thereof herein are intended to cover a non-exclusive inclusion, so that a process, method, object or device that includes a series of elements not only includes these elements, but also includes other elements that are not explicitly listed or are inherent to such a process, method, object or device. Without further limitations, the element limited by the statement “including a . . . ” does not preclude the presence of another identical element in a process, method, object or apparatus including that element. In addition, the scope of the methods and apparatuses in the implementations of this application is not limited to performing functions in the order shown or discussed, but may also include performing functions in a substantially simultaneous manner or in the opposite order according to the involved functions. For example, the described methods may be executed in a different order from the described ones, and various steps may also be added, omitted or combined. In addition, features described with reference to some examples may be combined in other examples.

Through the description of the above implementations, those skilled in the art can clearly understand that the above embodiment methods may be implemented through software and necessary universal hardware platforms. Of course, they may also be implemented through hardware. However, in many cases, the former is better. Based on this understanding, the technical solution of this application, or the part contributing to the existing technology, may be reflected in the form of a computer software product, and the computer software product is stored in a storage medium (such as an ROM/RAM, a magnetic disc or an optical disc), including several instructions to enable a terminal (the terminal may be a mobile phone, a computer, a server, an air conditioner or a network device) to execute the methods described in the embodiments of this application.

The embodiments of this application have been described above with reference to the drawings. However, this application is not limited to the above implementations. The above implementations are only exemplary rather than restrictive. Under the inspiration of this application, those skilled in the art may make many variations without departing from the essence and the scope of protection of the claims of this application, and the variations, however, still fall within the scope of protection of this application.

What is claimed is:

1. A measurement processing method, comprising:
measuring, by a terminal, a first signal; and
sending, by the terminal, a first measurement report to a first device or a serving cell of the terminal,
wherein:
a measurement quantity for the terminal to measure the first signal comprises at least one of:
a sensing measurement quantity,
a sensing performance evaluation index, or
a sensing measurement result,
the first signal comprises at least one of:
a sensing signal,
a reference signal,
a synchronization signal or
a data signal sent by the serving cell of the terminal or candidate target cells, and
the first device comprises at least one of a sensing network function, a sensing network element or a sensing management function.

2. The measurement processing method according to claim 1, wherein before the terminal measures the first signal, the method further comprises:
receiving, by the terminal, first measurement configuration information,
wherein the first measurement configuration information comprises at least one of:
a measurement object;
measurement report configuration information; or
a measurement identity.

3. The measurement processing method according to claim 2, wherein:
the measurement report configuration information comprises at least one of a reporting method or a measurement content to be reported by the terminal;
the measurement content comprises at least one of: a communication index, a sensing performance evaluation index, a sensing measurement quantity, or a sensing result;
the reporting method comprises periodic reporting or measurement event triggered reporting; and
when the reporting method comprises the measurement event triggered reporting, the first measurement configuration information further comprises a first measurement event.

4. The measurement processing method according to claim 3, wherein the first measurement event comprises at least one of:
that the sensing performance evaluation index of at least one candidate target cell or the serving cell satisfies a first preset condition;
that the sensing measurement quantity for at least one candidate target cell or the serving cell satisfies a second preset condition;
that the sensing result of at least one candidate target cell or the serving cell satisfies a third preset condition within a preset time period;
that parameter information of the first signal sent by at least one candidate target cell satisfies a sensing Quality of Service (QOS) minimum configuration requirement;
that a state of a sensing target changes;
that a position of the terminal changes; or
that a communication related index of at least one candidate target cell or the serving cell satisfies a fourth preset condition.

5. A measurement processing method, comprising:
receiving, by a second device, a first measurement report or a second measurement report, wherein the first measurement report is obtained by a terminal measuring a first signal, and the second measurement report is obtained by a third device measuring a second signal,
wherein:
a measurement quantity for the terminal to measure the first signal or a measurement quantity for the third device to measure the second signal comprises at least one of: a sensing measurement quantity, a sensing performance evaluation index, or a sensing measurement result;
the first signal comprises at least one of a sensing signal, a reference signal, a synchronization signal, or a data signal sent by a serving cell of the terminal or candidate target cells; or the second signal comprises at least one of a sensing signal, a reference signal, a synchronization signal, or a data signal sent by the terminal; and
the second device comprises a first device, and the first device comprises at least one of a sensing network function, a sensing network element and a sensing management function, or the second device is associated with the serving cell of the terminal.

6. The measurement processing method according to claim 5, further comprising:
determining, by the second device, whether to initiate switching according to the first measurement report or the second measurement report; and
determining, by the second device, at least one candidate target cell performing sensing when it is determined to initiate switching.

7. The measurement processing method according to claim 6, wherein determining, by the second device, at least one candidate target cell performing sensing comprises:
determining, by the second device, at least one candidate target cell performing sensing according to first information,
wherein the first information comprises at least one of:
position information of candidate target cells;
orientation information of antenna panels of candidate target cells;
sensing capability information of candidate target cells;
information of resources of candidate target cells available for sensing at present; or
channel state information of candidate target cells.

8. The measurement processing method according to claim 7, further comprising:
sending, by the second device, first request information to at least one candidate target cell, wherein the first request information is used for requesting at least one candidate target cell to perform sensing,
wherein the first request information comprises at least one of:
a soft handover request;
a sensing demand;
a sensing Quality of Service (QOS);
a sensing measurement quantity;
a sensing measurement result;
a sensing condition;
sensing target or sensing area prior information; or
a decision condition for deciding that sensing mode switching succeeds.

9. The measurement processing method according to claim 8, further comprising:
sending, by the second device, first indicator information to the serving cell, wherein the second device is the first device;
or
sending, by the second device, first indicator information to the first device, wherein the second device is associated with the serving cell of the terminal,
wherein the first indicator information is used for indicating that at least one candidate target cell performs sensing.

10. The measurement processing method according to claim 8, wherein the method further comprises:
receiving, by the second device, first refusal information, wherein the first refusal information is used for indicating that the device which sends the first refusal information does not perform sensing.

11. The measurement processing method according to claim 8, further comprising:
receiving, by the second device, first response information, wherein the first response information is used for indicating that the device which sends the first response information agrees to perform sensing.

12. The measurement processing method according to claim 11, further comprising:
determining, by the second device, at least one target cell of the candidate target cells as a cell performing sensing after switching according to the first response information; and
sending, by the second device, a switching command to the target cell, wherein the switching command comprises second parameter configuration information, wherein the second parameter configuration information comprises at least one of parameter information of the first signal or the second signal, resource information of the first signal or the second signal, or soft handover parameter configuration information.

13. The measurement processing method according to claim 11, wherein the first response information comprises first parameter configuration information, wherein the first parameter configuration information comprises at least one of parameter information of the first signal or the second signal, or resource information of the first signal or the second signal.

14. The measurement processing method according to claim 12, further comprising:
sending, by the second device, second information to the target cell, wherein the second information comprises at least one of:
part or all of historical sensing measurement quantities;
part or all of historical sensing results; or
sensing target or sensing area prior information.

15. The measurement processing method according to claim 5, further comprising:
sending, by the second device, first measurement configuration information or second measurement configuration information,
wherein the first measurement configuration information or the second measurement configuration information comprises at least one of:
a measurement object;
measurement report configuration information; or
a measurement identity.

16. The measurement processing method according to claim 15, wherein the measurement report configuration information comprises a reporting method, wherein the reporting method comprises periodic reporting or measurement event triggered reporting,
wherein when the reporting method comprises the measurement event triggered reporting, the first measurement configuration information further comprises a first measurement event or the second measurement configuration information further comprises a second measurement event.

17. The measurement processing method according to claim 16, wherein the first measurement event comprises at least one of:
the sensing performance evaluation index of at least one candidate target cell or the serving cell satisfies a first preset condition;
the sensing measurement quantity for at least one candidate target cell or the serving cell satisfies a second preset condition;
the sensing result of at least one candidate target cell or the serving cell satisfies a third preset condition within a preset time period;
parameter information of the first signal sent by at least one candidate target cell satisfies a sensing QoS minimum configuration requirement;
a state of a sensing target changes;
a position of the terminal changes; or
a communication related index of at least one candidate target cell or the serving cell satisfies a fourth preset condition.

18. The measurement processing method according to claim 16, wherein the second measurement event comprises at least one of:
a sensing performance evaluation index of the second signal satisfies a fifth preset condition;
a sensing measurement quantity for the second signal satisfies a sixth preset condition;
a sensing result of the second signal satisfies a seventh preset condition within a preset time period;
parameter information of the second signal satisfies a sensing QoS minimum configuration requirement;
a state of a sensing target changes;
a position of the terminal changes; or
a communication related index of the second signal satisfies an eighth preset condition.

19. A communication device, comprising: a processor; and a memory having a computer program or an instruction stored thereon, wherein the computer program or the instruction, when executed by the processor, causes the processor to performs operations comprising:
measuring a first signal; and
sending a first measurement report to a first device or a serving cell of the terminal,
wherein:
a measurement quantity for the terminal to measure the first signal comprises at least one of:
a sensing measurement quantity,
a sensing performance evaluation index, or
a sensing measurement result,
the first signal comprises at least one of:
a sensing signal,
a reference signal,
a synchronization signal or
a data signal sent by the serving cell of the terminal or candidate target cells, and
the first device comprises at least one of a sensing network function, a sensing network element or a sensing management function.

20. The communication device according to claim 19, wherein before measuring the first signal, the operations further comprise:
receiving first measurement configuration information,
wherein the first measurement configuration information comprises at least one of:
a measurement object;
measurement report configuration information; or
a measurement identity.
